(19) United States
(12) Patent Application Publication
(10) Pub. No.: US 2025/0071431 A1
(43) Pub. Date: Feb. 27, 2025

(54) IMAGING DEVICE, METHOD OF CONTROLLING IMAGING DEVICE, AND PROGRAM

(71) Applicant: Sony Group Corporation, Tokyo (JP)

(72) Inventor: Takashi TERASAWA, Kanagawa (JP)

(73) Assignee: Sony Group Corporation, Tokyo (JP)

(21) Appl. No.: 18/724,891

(22) PCT Filed: Dec. 22, 2022
(86) PCT No.: PCT/JP2022/047344

§ 371 Date: Jun. 27, 2024

(30) Foreign Application Priority Data
Jan. 11, 2022 (JP) 2022-002518

(51) Int. Cl. H04N 23/745; H04N 23/63; H04N 23/667; H04N 23/73

(52) U.S. Cl. CPC H04N 23/745; H04N 23/632; H04N 23/667; H04N 23/73

(57) ABSTRACT

The imaging device includes: an imaging element; a flicker detection unit that detects a flicker component from an image outputted from the imaging element; a correction unit that corrects the flicker component included in the image; and a control unit that makes a flicker detection adaptive setting that facilitates detection of the flicker component in the flicker detection unit in response to a shift from a normal imaging mode to a flicker detection mode, and causes an image display unit to display an image in which the flicker component has been corrected by a flicker correction unit.

### TECHNICAL FIELD

The present technology relates to an imaging device, a method of controlling an imaging device, and a program, and particularly relates to a technology of reducing an influence of flicker.

### BACKGROUND ART

In an imaging device (camera), an influence of flicker may occur in a captured image. For example, a so-called flicker in which illumination light flickers periodically occurs in a fluorescent lamp that has been widely used as a light source for indoor, a light emitting diode (LED) that has been widely used in recent years, and the like. Therefore, image quality degradation such as color unevenness due to such flicker occurs in an image captured under such an illumination environment.

Patent Documents 1 to 3 disclose techniques for reducing a flicker component generated in an image.

### CITATION LIST

### Patent Document

Patent Document 1: WO 2018/034076 A
Patent Document 2: Japanese Patent Application Laid-Open No. 2019-134257
Patent Document 3: Japanese Patent Application Laid-Open No. 2015-88770

### SUMMARY OF THE INVENTION

### Problems to be Solved by the Invention

By the way, for example, since visibility of an image displayed on an image display unit is prioritized, there is a possibility that the flicker detection accuracy deteriorates when an attempt is made to detect a flicker component on the basis of the image. On the other hand, when an image in which a flicker component is easily detected is displayed on the image display unit, the flicker component becomes conspicuous in the image, and thus there is a possibility that visibility deteriorates.

Therefore, the present technology proposes a technology that achieves both improvement in flicker detection accuracy and visibility of an image displayed on an image display unit.

### Solutions to Problems

An imaging device according to the present technology includes: an imaging element; a flicker detection unit that detects a flicker component from an image outputted from the imaging element; a flicker correction unit that corrects the flicker component included in the image; and a control unit that makes a flicker detection adaptive setting that facilitates detection of the flicker component in the flicker detection unit in response to a shift from a normal imaging mode to a flicker detection mode, and causes an image display unit to display an image in which the flicker component has been corrected by the flicker correction unit.

Therefore, the imaging device can easily detect flicker by the flicker detection unit.

### BRIEF DESCRIPTION OF DRAWINGS

FIG. 1 is a view illustrating an appearance of an imaging device according to an embodiment.

FIG. 2 is a view illustrating an appearance of an imaging device according to an embodiment.

FIG. 3 is a diagram illustrating an internal configuration of an imaging device.

FIG. 4 is a diagram for explaining a configuration of a digital signal processing unit.

FIG. 5 is a diagram for explaining a menu screen displayed on an image display unit.

FIG. 6 is a diagram for explaining an imaging standby screen displayed on an image display unit.

FIG. 7 is a diagram for explaining a relationship between a shutter speed and flicker.

FIG. 8 is a diagram for explaining a relationship between a curtain speed and flicker.

FIG. 9 is a flowchart for explaining a flow of changing a setting at the time of flicker scan processing.

FIG. 10 is a diagram for explaining flicker detection processing in Operation Example 1.

FIG. 11 is a diagram for explaining a method of calculating a flicker frequency in Operation Example 1.

FIG. 12 is a flowchart for explaining a flow of flicker scan processing in Operation Example 1.

FIG. 13 is a flowchart for explaining a flow of flicker detection processing in Operation Example 1.

FIG. 14 is a flowchart for explaining a flow of flicker correction processing in Operation Example 1.

FIG. 15 is a flowchart for explaining a flow of flicker correction processing by a shutter speed correction mode.

FIG. 16 is a diagram for explaining flicker detection processing in Operation Example 2.

FIG. 17 is a diagram for explaining a relationship between a shutter speed and flicker intensity.

FIG. 18 is a flowchart for explaining a flow of flicker detection processing in Operation Example 2.

FIG. 19 is a diagram for explaining flicker detection processing in Operation Example 3.

FIG. 20 is a diagram for explaining an example of an image showing a flicker occurrence state.

FIG. 21 is a diagram for explaining flicker correction processing in a case where a plurality of flicker regions is generated.

FIG. 22 is a flowchart for explaining a flow of flicker correction processing in a case where a plurality of flicker regions is detected.

FIG. 23 is a diagram for explaining an example of a flicker adjustment UI.

FIG. 24 is a flowchart for explaining a flow of flicker adjustment UI display processing in Operation Example 4.

FIG. 25 is a flowchart for explaining a flow of shutter speed change processing in response to an operation of the flicker adjustment UI.

### MODE FOR CARRYING OUT THE INVENTION

Hereinafter, an embodiment will be described in the following order.
<1. Configuration of imaging device>
<2. Operation examples>
<3. Variations>
<4. Summary>

Note that the meaning of some of the terms used in the present disclosure will be described.

The “image” is a term including a still image and a moving image.

The “line” refers to a line of pixels aligned in the horizontal direction in a still image or an image that is one frame of a moving image.

The “live view image” or the “LV image” refers to an image captured by the imaging element and displayed on the image display unit in a state visible to the user at the time of imaging without image recording and at the time of imaging with image recording. That is, an image showing a scene on the subject side in real time is referred to.

Note that the live view image is generally generated and displayed as a low-resolution image according to the number of pixels that can be displayed on the image display unit.

### 1. Configuration of Imaging Device

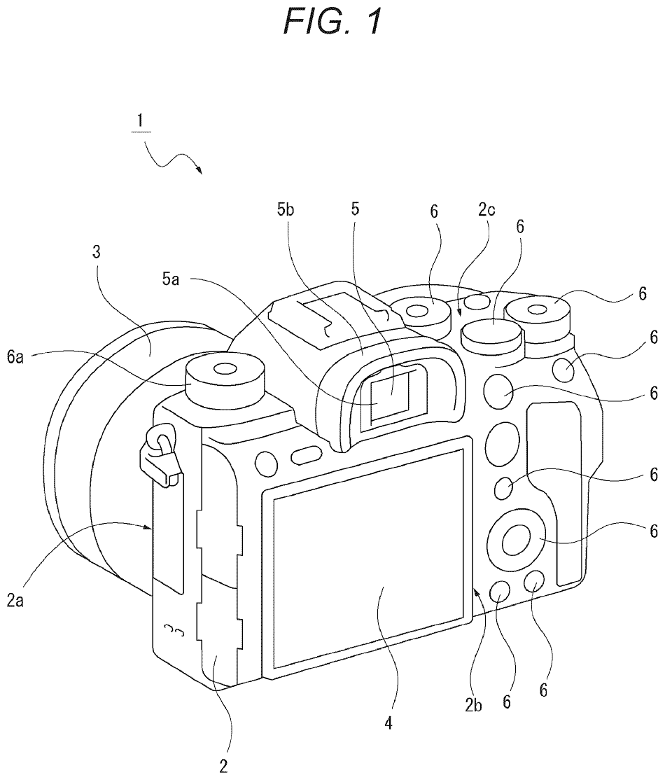

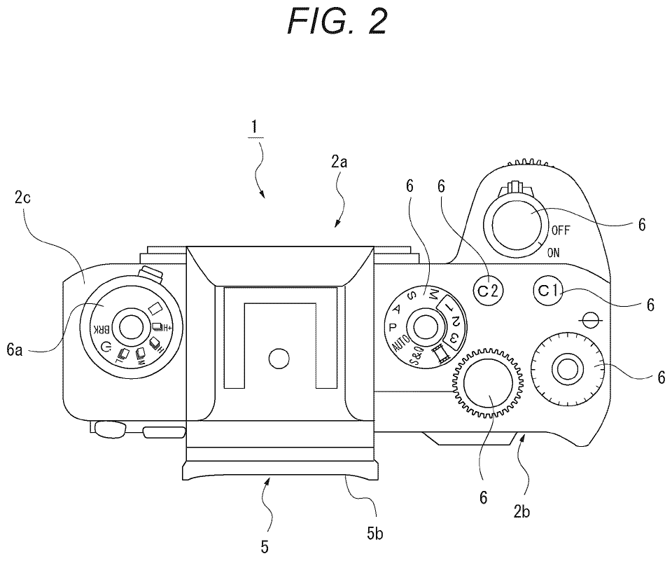

FIGS. 1 and 2 are views illustrating an appearance of an imaging device 1 according to an embodiment. FIG. 2 illustrates a camera housing 2 from which a lens barrel 3 has been detached. Note that, in the description below, the subject side will be referred to as the front, and the imaging operator (user) side will be referred to as the back. Furthermore, the imaging device 1 illustrated in FIGS. 1 and 2 is an example, and a part thereof may be included in an external device connected in a wireless or wired manner, or the imaging device 1 may include a processing unit other than the units illustrated below.

As illustrated in FIGS. 1 and 2, the imaging device 1 includes the camera housing 2 having respective necessary components disposed inside and outside, and the lens barrel 3 that is detachable from the camera housing 2 and is attached to a front surface portion 2a.

Note that the lens barrel 3 that is detachable as a so-called interchangeable lens is an example, and the lens barrel 3 may be a lens barrel that cannot be detached from the camera housing 2.

A rear monitor 4 is disposed on a back surface portion 2b of the camera housing 2. The rear monitor 4 displays a live view image, a reproduced image of a recorded image, or the like.

The rear monitor 4 includes, for example, a display device such as a liquid crystal display (LCD) or an organic electro-luminescence (EL) display.

The rear monitor 4 is rotatable with respect to the camera housing 2. For example, the rear monitor 4 is rotatable in such a manner that an upper end portion thereof serves as a rotation axis and a lower end portion thereof moves backward. Note that a right end portion or a left end portion of the rear monitor 4 may serve as a rotation axis. Moreover, rotation in directions around a plurality of axes may be made possible.

An electric viewfinder (EVF) 5 is disposed on an upper surface portion 2c of the camera housing 2. The EVF 5 includes an EVF monitor 5a, and a frame-like enclosing portion 5b projecting backward so as to surround upper, right, and left sides of the EVF monitor 5a.

The EVF monitor 5a is formed with an LCD, an organic EL display, or the like. The EVF monitor 5a displays a live view image, a reproduced image of a recorded image, or the like. Note that an optical view finder (OVF) may be provided instead of the EVF monitor 5a.

Various operation tools 6 are provided on the back surface portion 2b and the upper surface portion 2c. Examples of the operation tools 6 include a shutter button (release button), a menu activation button, an enter button, a cross key, a cancel button, a zoom key, a slide key, and the like.

These operation tools 6 include various forms such as a button, a dial, and a pressable and rotatable composite operation tool. The operation tools 6 in various forms enable, for example, a shutter operation, a menu operation, a reproduction operation, a mode selection operation, a focus operation, a zoom operation, a parameter change operation, and the like.

Furthermore, the operation tools 6 further include a touch panel provided on the front surface of the rear monitor 4.

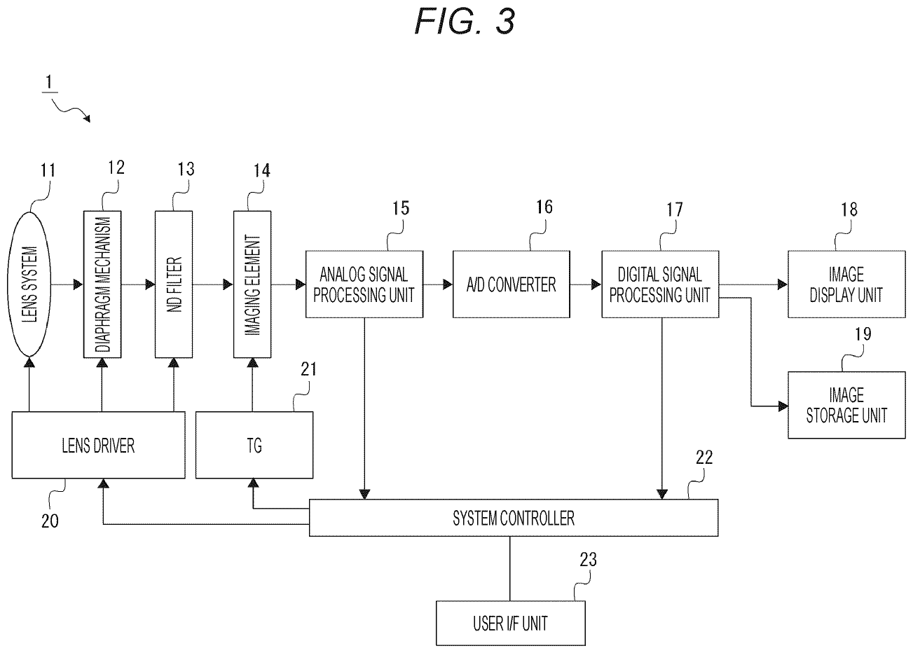

FIG. 3 is a diagram illustrating the internal configuration of the imaging device 1. As illustrated in FIG. 3, the imaging device 1 includes a lens system 11, a diaphragm mechanism 12, a neutral density (ND) filter 13, an imaging element 14, an analog signal processing unit 15, an analog/digital (A/D) converter 16, a digital signal processing unit 17, an image display unit 18, an image storage unit 19, a lens driver 20, a timing generator 21 (referred to as TG in the drawing), a system controller 22, and a user interface unit 23 (referred to as a user I/F unit in the drawing).

The lens system 11 is provided with various lenses such as a zoom lens, a focus lens, and a condenser lens, a drive mechanism for the zoom lens, and a drive mechanism for the focus lens, and guides light from a subject to the imaging element 14. The lens system 11 may be provided with a mechanical shutter (e.g., a focal plane shutter).

The diaphragm mechanism 12 is configured to be able to mechanically adjust the amount of light from a subject by adjusting the aperture.

The ND filter 13 is a filter having a predetermined transmittance, and changes the amount of light entering the imaging element 14 by being inserted into and removed from an optical path of light from a subject.

The imaging element 14 includes, for example, a complementary metal oxide semiconductor (CMOS) sensor, and light from a subject enters through the lens system 11. The imaging element 14 obtains an analog image signal by photoelectric conversion. In the present embodiment, it is assumed that the imaging element 14 is a CMOS sensor that operates in a so-called rolling shutter system in which the start and end of exposure are set for a large number of pixels for each line by an electronic shutter.

The imaging element 14 is formed by, for example, two-dimensionally arraying a plurality of pixels including a photodiode, a transfer transistor, a switching transistor, an amplification transistor, a reset transistor, and the like on a CMOS substrate, and forming a vertical scanning circuit, a horizontal scanning circuit, and an image signal output circuit.

The imaging element 14 may be either a primary color system or a complementary color system, and an analog image signal obtained from the imaging element 14 is a primary color signal of each color of RGB or a color signal of a complementary color system. Furthermore, the imaging element 14 may be configured not to have a color filter, and an analog image signal obtained from the imaging element 14 may be a black-and-white image signal.

The analog signal processing unit 15 includes, for example, an integrated circuit (IC). The analog signal processing unit 15 performs, for example, correlated double sampling (CDS) processing, automatic gain control (AGC) processing, or the like on an inputted analog image signal.

The A/D converter 16 converts an analog signal outputted from the analog signal processing unit 15 into a digital image signal (e.g., an RGB primary color signal).

The digital signal processing unit 17 is configured as an image processing processor by an arithmetic processing device such as a digital signal processor (DSP), for example. The digital signal processing unit 17 performs various types of signal processing on an inputted digital image signal. Note that the signal processing by the digital signal processing unit 17 will be described later in detail.

Furthermore, the digital signal processing unit 17 performs, for example, compression encoding for recording or communication, formatting, generation or addition of metadata, and the like on the image data obtained by performing various types of signal processing, and generates a file for recording or communication.

For example, an image file in a format such as joint photographic experts group (JPEG), tagged image file format (TIFF), or graphics interchange format (GIF) is generated as a still image file. It is also conceivable to generate an image file as an MP4 format or the like that is used for recording a moving image and sound conforming to MPEG-4.

Note that it is also conceivable to generate an image file as raw image data.

The image display unit 18 performs various displays for the user, and is, for example, the rear monitor 4 or the EVF monitor 5a disposed in the housing of the imaging device 1 as illustrated in FIG. 1.

For example, the image display unit 18 displays an image based on an image file stored in the image storage unit 19. Furthermore, the image display unit 18 displays a live view image at the time of imaging without image recording and at the time of imaging with image recording. Furthermore, the image display unit 18 also displays various operation menus, icons, messages, and the like, that is, a graphical user interface (GUI), on the basis of an instruction from the system controller 22.

Note that, in the present embodiment, the imaging device 1 includes the image display unit 18. However, the imaging device 1 may not include the image display unit 18, and an image may be displayed on an image display unit of an external device (not illustrated) connected in a wired or wireless manner.

The image storage unit 19 is, for example, a nonvolatile memory, and stores an image file processed by the digital signal processing unit 17. Note that, in the description below, image data and an image file may be referred to simply as an image.

The lens driver 20 is provided with, for example, a motor driver for a zoom lens drive motor, a motor driver for a focus lens drive motor, a motor driver for a motor of the diaphragm mechanism 12, a motor driver for moving the ND filter 13, and the like.

In response to an instruction from the system controller 22, the lens driver 20 applies a drive current or a drive voltage to a corresponding driver to execute movement of the focus lens and the zoom lens, opening and closing of the diaphragm blade of the diaphragm mechanism 12, movement of the ND filter 13, and the like.

The timing generator 21 generates a drive pulse necessary for driving the imaging element 14 in response to an instruction from the system controller 22 and supplies the drive pulse to the imaging element 14. The imaging element 14 is driven by the timing generator 21 to capture a subject image (electronic shutter), and an image of the subject image is acquired. Furthermore, the exposure time at the time of capturing an image is controlled by adjusting the speed of the electronic shutter of the imaging element 14 by the timing generator 21. Hereinafter, the speed of the electronic shutter will be referred to as a shutter speed.

Note that the shutter speed, which generally indicates the exposure time(s) of each pixel of the imaging element 14, is defined by the reciprocal (Hz) of the exposure time in the present embodiment. For example, in a case where the exposure time is 0.1 s, the shutter speed of the present embodiment is 10 Hz.

The system controller 22 includes a microcomputer (an arithmetic processing device) provided with a central processing unit (CPU), a read only memory (ROM), and a random access memory (RAM). The system controller 22 controls the entire imaging device 1 by executing a program stored in a ROM or the like.

For example, the system controller 22 controls an instruction of an analog gain in the analog signal processing unit 15, an instruction of various types of signal processing in the digital signal processing unit 17, an imaging operation and a recording operation corresponding to an operation by the user, a reproduction operation of a recorded image file, and the like.

Furthermore, the system controller 22 performs drive control of the focus lens and the zoom lens in response to autofocus control, manual focus operation, zoom operation, and the like.

The user interface unit 23 collectively indicates input devices for the user to perform various operation inputs, and is, for example, the operation tools 6 (keys, dials, a touch panel, a touch pad, etc.) arranged on the housing of the imaging device 1 as illustrated in FIG. 1.

An operation by the user is detected by the user interface unit 23, and a signal corresponding to the inputted operation is transmitted to the system controller 22.

Here, in the present embodiment, a still image capturing mode for capturing a still image and a moving image capturing mode for capturing a moving image are prepared as the normal imaging mode that is a normal setting not considering the easiness of detection of the flicker component. Then, in the imaging device 1, either the still image capturing mode or the moving image capturing mode is set by a predetermined operation of the operation tools 6, and an image is captured in the set mode. Note that, in the imaging device 1, only one of the still image capturing mode or the moving image capturing mode may be prepared as the normal imaging mode.

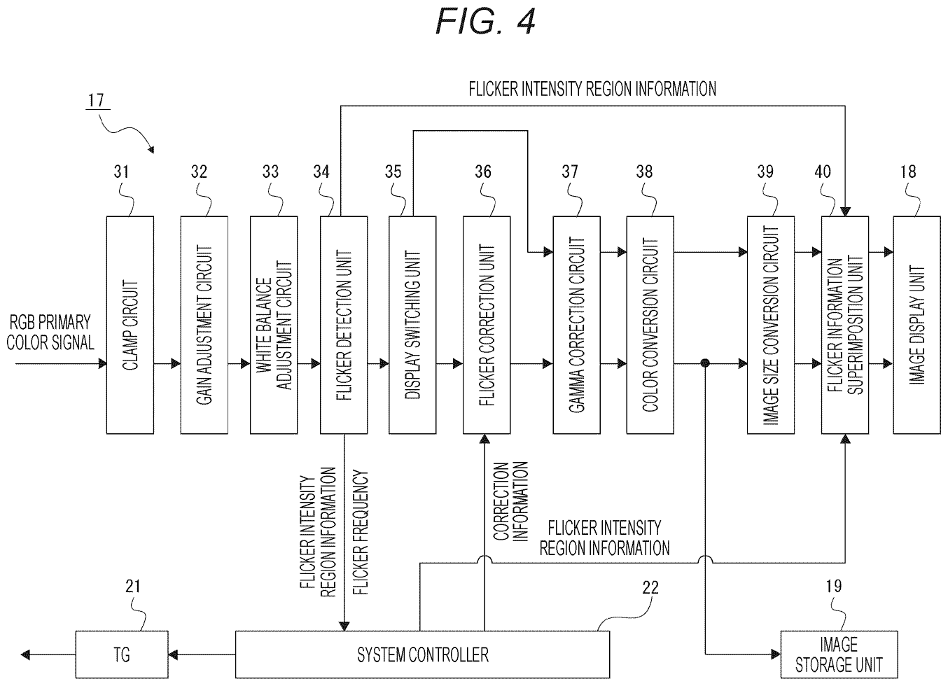

FIG. 4 is a diagram for explaining a configuration of the digital signal processing unit 17. FIG. 4 illustrates the image display unit 18, the image storage unit 19, the timing generator 21, and the system controller 22 together with each configuration of the digital signal processing unit 17.

As illustrated in FIG. 4, the digital signal processing unit 17 functions as a clamp circuit 31, a gain adjustment circuit 32, a white balance adjustment circuit 33, a flicker detection unit 34, a display switching unit 35, a flicker correction unit 36, a gamma correction circuit 37, a color conversion circuit 38, an image size conversion circuit 39, and a flicker information superimposition unit 40 when executing flicker scan processing of Operation Examples 1 to 4 to be described later.

Note that, in the digital signal processing unit 17, some or all of the functional units function in Operation Examples 1 to 4, and there are functional units that do not function (do nothing) in any of Operation Examples 1 to 4.

The clamp circuit 31 clamps the black level of the inputted RGB primary color signal to a predetermined level. The gain adjustment circuit 32 adjusts the gain of the RGB primary color signal after clamping according to the exposure amount. The white balance adjustment circuit 33 adjusts the white balance of an RGB primary color signal after the gain adjustment.

The flicker detection unit 34 detects a flicker component (also referred to simply as flicker) for either the entire frame or each predetermined region in a frame regarding an RGB primary color signal obtained after white balance adjustment, that is, the frame of the image obtained by imaging by the imaging element 14.

Specifically, in the case of targeting the entire frame, the flicker detection unit 34 calculates the frequency (hereinafter, a flicker frequency) of the flicker occurring in the entire frame, and sends the frequency to the system controller 22. Furthermore, the flicker detection unit 34 calculates the intensity (hereinafter, referred to as flicker intensity) of the flicker occurring in the entire frame, and sends flicker intensity region information indicating the flicker intensity to the system controller 22.

In the case of targeting each predetermined region in the frame, the flicker detection unit 34 calculates the flicker frequency and the flicker intensity for each predetermined region, and detects a region (hereinafter, referred to as a flicker region) where the flicker is occurring on the basis of the calculation result.

Then, the flicker detection unit 34 sends the flicker frequency to the system controller 22, and sends the flicker intensity region information indicating the flicker intensity and the flicker region to the flicker information superimposition unit 40 and the system controller 22.

Note that the flicker detection unit 34 may calculate the phase (an initial phase of the flicker stripe) of the flicker occurring in the entire frame or the flicker region, and send the phase to the system controller 22 in addition to the flicker frequency and the flicker intensity region information.

The system controller 22 controls the timing generator 21 on the basis of the flicker frequency inputted from the flicker detection unit 34 to operate the imaging element 14 so as not to cause flicker, thereby correcting (reducing) the flicker as a result. Furthermore, the system controller 22 causes the flicker correction unit 36 to correct flicker of an image obtained by imaging by the imaging element 14.

When the flicker correction unit 36 corrects the flicker, the display switching unit 35 switches between displaying an image in which the flicker has not been reduced on the image display unit 18 and displaying an image in which the flicker has been reduced. Here, for example, switching can be performed in response to a user operation on the operation tools 6.

In a case where an image in which flicker is occurring is displayed on the image display unit 18, the display switching unit 35 causes an RGB primary color signal that has not been subjected to flicker correction by the flicker correction unit 36 to be inputted to the gamma correction circuit 37.

On the other hand, in a case where an image in which flicker has been corrected is displayed on the image display unit 18, the display switching unit 35 inputs an RGB primary color signal that has been subjected to flicker correction in the flicker correction unit 36 to the gamma correction circuit 37.

The flicker correction unit 36 corrects the flicker of the RGB primary color signal (image) on the basis of the correction information inputted from the system controller 22. Note that, in a case where the flicker correction unit 36 controls the timing generator 21 to operate the imaging element 14 so that the flicker does not occur and corrects the flicker as a result, the flicker correction unit 36 sends the RGB primary color signal (image) to the gamma correction circuit 37 without correcting the flicker.

The gamma correction circuit 37 converts the gradation of the RGB primary color signal obtained after the flicker correction or without the flicker correction.

The color conversion circuit 38 generates a luminance signal Y and color difference signals R-Y and B-Y as image data from an RGB primary color signal obtained after gamma correction. The image data generated here is stored in the image storage unit 19 as an image file.

The image size conversion circuit 39 executes reduction processing of reducing the image size (the number of pixels) so that the image based on the image data can be entirely displayed on the image display unit 18.

On the basis of the flicker intensity region information detected by the flicker detection unit 34, the flicker information superimposition unit 40 displays the flicker region and the flicker intensity of the image whose image size has been changed by the image size conversion circuit 39 so that the user can recognize the flicker region and the flicker intensity.

At this time, the flicker intensity region information may be inputted to the flicker information superimposition unit 40 from one of the flicker detection unit 34 or the system controller 22 according to the processing load of the system controller 22, for example. In a case where the processing load of the system controller 22 is low, the flicker intensity region information corresponding to the image size changed by the reduction processing by the system controller 22 is inputted to the flicker information superimposition unit 40. On the other hand, in a case where the processing load of the system controller 22 is high, the flicker intensity region information is directly inputted from the flicker detection unit 34 to the flicker information superimposition unit 40.

Furthermore, the flicker intensity region information may be inputted from only one of the flicker detection unit 34 or the system controller 22.

### 2. Operation Examples

Hereinafter, the flicker scan processing performed by the flicker detection unit 34, the flicker correction unit 36, the flicker information superimposition unit 40, and the system controller 22 will be mainly described.

Here, as described above, since the imaging element 14 is a CMOS sensor that operates in a rolling shutter system, the exposure timing is different for each horizontal line. Accordingly, in a case where a light source such as a fluorescent lamp or an LED is lit (blinks) at a predetermined frequency, the amount of received light changes for each horizontal line in the imaging element 14.

Thus, in the image outputted from the imaging element 14, in-plane flicker that is a phenomenon in which a line having a signal level (pixel value) of an RGB primary color signal that is higher than the average value and a line having a signal level of the RGB primary color signal that is lower than the average value alternately exist may occur. Note that the in-plane flicker can be approximated by a sine wave having a frequency, an amplitude, and a phase.

Thus, the digital signal processing unit 17 and the system controller 22 execute flicker scan processing of detecting and correcting flicker from an image obtained by imaging by the imaging element 14, and displaying an image in which the flicker has been corrected on the image display unit 18.

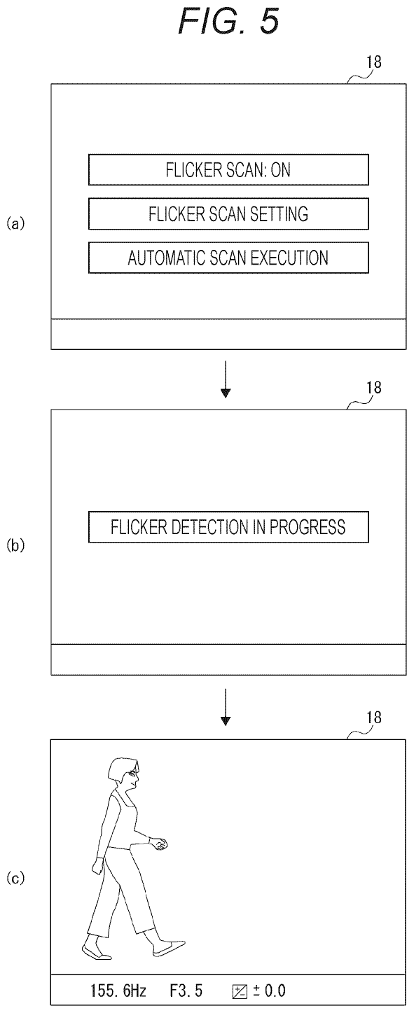

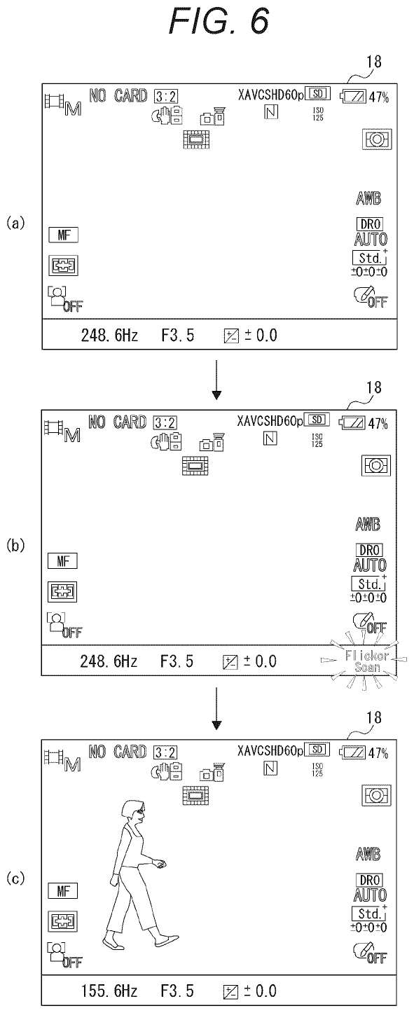

FIG. 5 is a view for explaining a menu screen displayed on the image display unit 18. FIG. 6 is a view for explaining an imaging standby screen displayed on the image display unit 18.

As illustrated in FIG. 5(a), the imaging device 1 is provided with a menu screen corresponding to the flicker scan processing. In a case where the display of the menu screen corresponding to the flicker scan processing is selected in response to a user operation, the system controller 22 displays the menu screen corresponding to the flicker scan processing on the image display unit 18.

On the menu screen corresponding to the flicker scan processing, for example, a flicker scan enabling/disabling button for switching between enabling and disabling of the flicker scan processing, a flicker scan setting button for displaying a screen for making various settings of the flicker scan processing, and an automatic scan execution button for immediately executing the flicker scan processing are provided in this order from the top.

Then, in a case where the automatic scan execution button is operated on the menu screen, the digital signal processing unit 17 and the system controller 22 execute the flicker scan processing.

In the flicker scan processing, the normal imaging mode is shifted to a flicker detection mode to be described later in detail, the imaging element 14 is set as the flicker detection adaptive setting that facilitates detection of flicker in the flicker detection unit 34, and an image is outputted with the flicker detection adaptive setting.

During execution of the flicker scan processing, as illustrated in FIG. 5(b), the system controller 22 displays, for example, an icon labeled “flicker detection in progress” to notify the user that the flicker scan processing is being executed.

Furthermore, in a case where flicker is corrected in the flicker scan processing, the digital signal processing unit 17 and the system controller 22 display an image obtained after the flicker correction on the image display unit 18 and display the shutter speed in a lower part of the image display unit 18 as illustrated in FIG. 5(c) (“155.6 Hz” in the lower part of FIG. 5).

Furthermore, in a case where the shutter speed is changed in the flicker scan processing, the digital signal processing unit 17 and the system controller 22 update and display the changed shutter speed in the lower part of the image display unit 18.

Then, the flicker scan processing is terminated in a case where a user operation of changing the shutter speed is performed during execution of the flicker scan processing, in a case where a user operation of stopping the flicker scan processing is performed, and in a case where a user operation of closing the flicker scan screen is performed.

Furthermore, as illustrated in FIG. 6(a), the system controller 22 causes the image display unit 18 to display a live view image together with various icons during image capturing standby. Then, the digital signal processing unit 17 and the system controller 22 execute the flicker scan processing in a case where an operation tool 6 to which an operation of executing the flicker scan processing is assigned is operated.

During execution of the flicker scan processing, as illustrated in FIG. 6(b), the system controller 22 displays, for example, an icon labeled “Flicker Scan” in a blinking manner in order to notify the user that the flicker scan processing is being executed. Furthermore, the system controller 22 displays the shutter speed in a lower part of the image display unit 18 (“248.6 Hz” in FIG. 6(b)).

Furthermore, in a case where the shutter speed is changed in the flicker scan processing, the digital signal processing unit 17 and the system controller 22 update and display the changed shutter speed in a lower part of the image display unit 18 as illustrated in FIG. 6(c) (“248.6 Hz” is changed to “155.6 Hz” in the figure).

Then, the digital signal processing unit 17 and the system controller 22 terminate the flicker scan processing in a case where a user operation of changing the shutter speed is performed, in a case where a user operation of stopping the flicker scan processing is performed, in a case where an operation (e.g., a pressing operation of an auto exposure lock (AEL) button or a half-pressing operation of a release button) for locking a parameter (e.g., F value, shutter speed, ISO sensitivity, etc.) related to imaging is performed, and in a case where an operation of closing the flicker scan screen is performed.

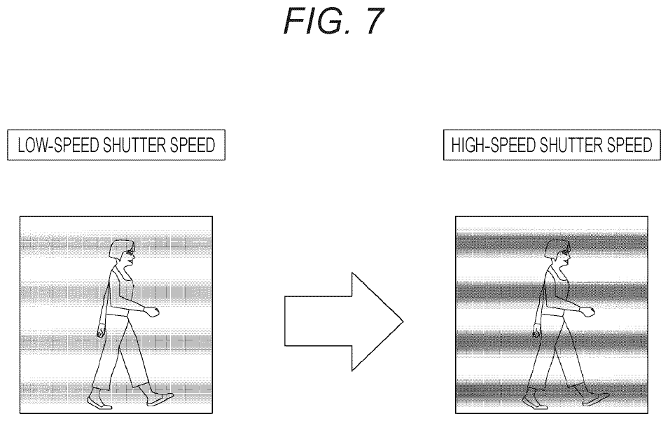

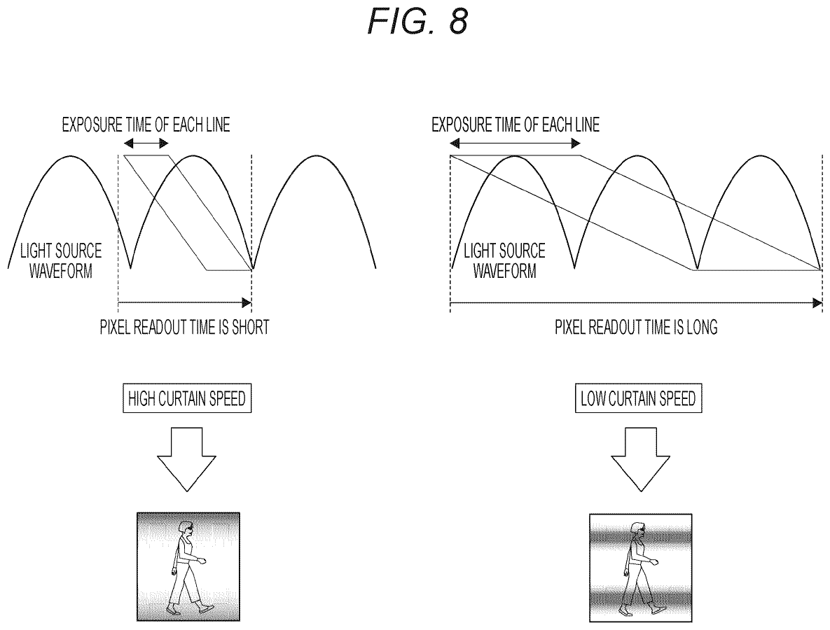

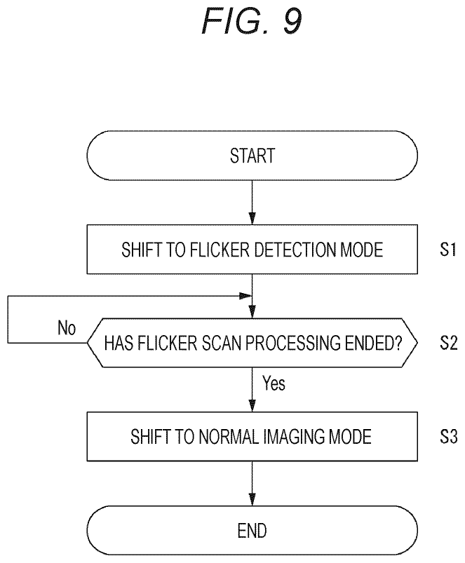

FIG. 7 is a diagram for explaining a relationship between a shutter speed and flicker. FIG. 8 is a diagram for explaining a relationship between a curtain speed and flicker. FIG. 9 is a flowchart for explaining a flow of changing a setting at the time of flicker scan processing. Note that, in FIG. 8, the light source waveform is indicated by a sine wave, and the curtain speed, which is the time (hereinafter, referred to as a pixel readout time) from reading of the pixel value of the first pixel (upper left) of the head line to reading of the pixel value of the last pixel (lower right) of the last line of the imaging element 14, is schematically illustrated in a parallelogram.

By the way, as illustrated in FIG. 7, in a case where the shutter speed is relatively low (low-speed shutter speed), the exposure time at each pixel in the imaging element 14 becomes long as compared with a case where the shutter speed is relatively high (high-speed shutter speed), and thus, the luminance becomes high as a whole, and the brightness difference of the flicker becomes small. Accordingly, in a case where the shutter speed is relatively low, it is difficult to detect flicker as compared with a case where the shutter speed is relatively high.

Furthermore, as illustrated in FIG. 8, in a case where the pixel readout time is short and the curtain speed is relatively high (high curtain speed), the number of times of overlapping with the flicker cycle is reduced, and the number of flicker stripes is reduced, as compared with a case where the pixel readout time is long and the curtain speed is relatively low (low curtain speed). Accordingly, in a case where the curtain speed is relatively high, it is difficult to detect flicker as compared with a case where the curtain speed is relatively low.

Furthermore, for example, when trying to detect and correct flicker on the basis of an image of the number of pixels displayed on the image display unit 18, the number of pixels is smaller than that of an image captured using all the pixels of the imaging element 14, and thus, the number of flicker stripes is reduced. Accordingly, in a case where processing is performed on an image with a small number of pixels, it is difficult to detect flicker as compared with a case where processing is performed on an image with a large number of pixels.

Thus, as illustrated in FIG. 9, in step S1, the system controller 22 shifts from the normal imaging mode to the flicker detection mode before executing the flicker scan processing. The flicker detection mode is a mode that makes flicker detection in the flicker detection unit 34 easier than in the normal imaging mode, and sets the setting for the imaging element 14 to the flicker detection adaptive setting.

As the flicker detection adaptive setting, the system controller 22 sets a shutter speed suitable for detecting the flicker in the flicker detection unit 34, a curtain speed (pixel readout time) suitable for detecting the flicker, and the number of pixels suitable for detecting the flicker.

For example, the system controller 22 instructs the timing generator 21 to set the shutter speed to be higher than a predetermined speed. Note that increasing the shutter speed means setting the shutter speed to be equal to or higher than a predetermined speed that is set as a high speed in advance within a settable shutter speed range. Here, for example, the frequency (e.g., 1000 Hz) of the dynamic blinking of the LED is set to a predetermined speed.

Furthermore, the system controller 22 instructs the timing generator 21 to set the curtain speed to be lower than a predetermined speed. That is, the system controller 22 instructs the timing generator 21 to set the pixel readout time to be longer than a predetermined time. Note that decreasing the curtain speed means setting the curtain speed to be equal to or lower than a predetermined speed that is set as a low speed in advance within a settable curtain speed range. Here, for example, the curtain speed is set to a predetermined speed so that a plurality of flicker stripes appears in the captured image when the LED is lit (dynamic blinking).

Accordingly, the shutter speed is not necessarily set to be higher than the shutter speed set before the execution of the flicker scan processing, but is set to a shutter speed set in advance as a high speed. Similarly, the curtain speed is not necessarily set to be lower than the curtain speed set before the execution of the flicker detection correction processing, but is set to a curtain speed set in advance as a low speed.

Furthermore, the system controller 22 instructs the timing generator 21 to control the addition number of addition readout of pixels of the imaging element 14 via the timing generator 21. Therefore, the system controller 22 can control the number of pixels outputted from the imaging element 14 to be the number of pixels suitable for flicker detection. Note that the number of pixels suitable for flicker detection is the number of pixels that facilitates detection of flicker, and is, for example, the total number of pixels of the imaging element 14 larger than that in the normal imaging mode. Note that, in the case of the total number of pixels, addition readout of pixels is not performed in the imaging element 14.

In this manner, by setting the shutter speed, the curtain speed, and the number of pixels of the image used for flicker detection as the flicker detection adaptive setting as described above, the flicker scan processing (flicker detection processing) can be performed on the basis of the image in which flicker is relatively easily detected. Note that it is only required to set any one of the shutter speed, the curtain speed, or the number of pixels of the image used for flicker detection in the flicker detection adaptive setting.

Thereafter, in step S2, the system controller 22 determines whether the flicker scan processing has ended or not, and repeats step S2 until the flicker scan processing ends. On the other hand, in a case where the flicker scan processing has ended (Yes in step S2), the system controller 22 shifts from the flicker detection mode to the normal imaging mode in step S3.

Here, the system controller 22 shifts to the normal imaging mode in response to the detection of the flicker component by the flicker detection unit 34 or the correction of the flicker in the flicker detection mode. Specifically, in a case where flicker correction in a shutter speed correction mode to be described later is not performed, the system controller 22 instructs the timing generator 21 to return to the shutter speed, the curtain speed, and the number of pixels used before the flicker scan processing is executed.

Therefore, the imaging device 1 can output an image at the shutter speed, the curtain speed, and the number of pixels suitable for flicker detection set before the flicker scan processing is executed.

Next, the flicker scan processing will be described using examples as Operation Examples 1 to 4.

Note that the imaging device 1 may be configured to perform processing based on one operation example among the plurality of operation examples described below, may be configured to be able to perform processing based on all the operation examples, or may be configured to perform processing by combining some operation examples.

### 2-1. Operation Example 1

### [2-1-1. Flicker Detection Processing]

In Operation Example 1, flicker detection processing in which a flicker frequency is calculated by the flicker detection unit 34 is executed, and flicker correction processing is performed by setting a shutter speed via the timing generator 21, or flicker correction by the flicker correction unit 36.

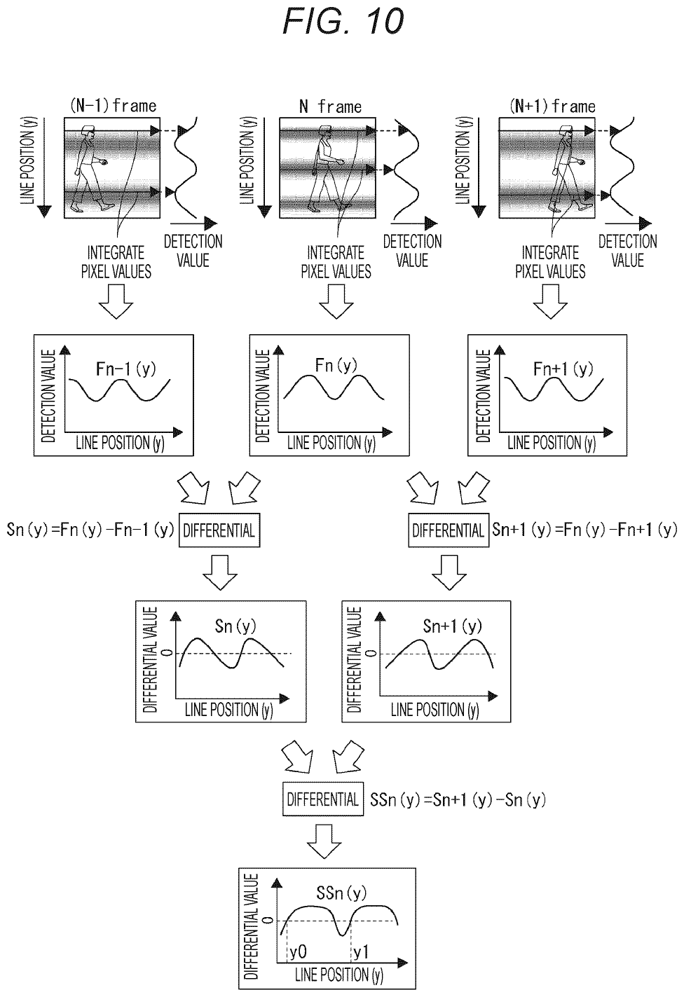

FIG. 10 is a diagram for explaining flicker detection processing in Operation Example 1. As illustrated in FIG. 10, the flicker detection unit 34 integrates the signal levels of inputted RGB primary color signals for one line to calculate a detection value Fn(y). The calculated detection value Fn(y) is stored and held for flicker detection in subsequent frames. Note that y represents a line position from the upper part of the image.

The flicker detection unit 34 calculates a differential value Sn(y) between a detection value Fn(y) and a detection value Fn−1(y) by subtracting the detection value Fn−1(y) one frame before in the same line position from the calculated detection value Fn(y).

Furthermore, the flicker detection unit 34 calculates a differential value Sn+1(y) between a detection value Fn+1(y) and a detection value Fn(y) by subtracting the detection value Fn+1(y) one frame after in the same line position from the calculated detection value Fn(y). In the processing of calculating the differential values Sn(y) and Sn+1(y), a flicker component from which the influence of the moving subject has been sufficiently removed remains in the differential values Sn(y) and Sn+1(y), and thus, functions as a high-pass filter. Furthermore, the differential values Sn(y) and Sn+1(y) correspond to high-pass filter processing result values obtained by performing high-pass filter processing.

Subsequently, the system controller 22 calculates a differential value SSn(y) between the differential value Sn+1(y) and the differential value Sn(y) by subtracting the differential value Sn(y) between the detection value Fn(y) and the detection value Fn−1(y) from the differential value Sn+1(y) between the detection value Fn(y) and the detection value Fn+1(y).

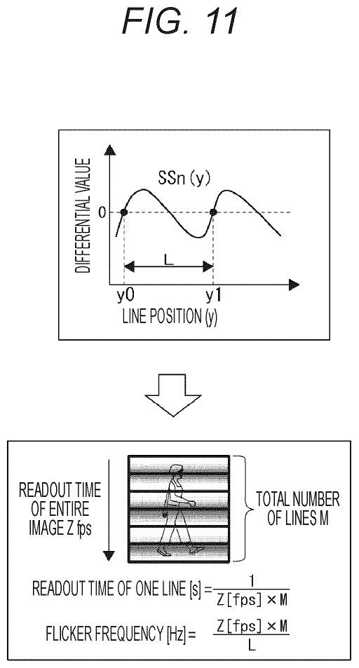

FIG. 11 is a diagram for explaining a method of calculating a flicker frequency in Operation Example 1. The differential value SSn(y) described above between the differential value Sn+1(y) and the differential value Sn(y) indicates a change rate of the detection value Fn(y). Accordingly, the flicker frequency can be calculated on the basis of a difference between line positions to be zero-cross positions at which the differential value SSn(y) changes from a negative value to a positive value or zero-cross positions at which the differential value SSn(y) changes from a positive value to a negative value.

Thus, as illustrated in FIG. 11, the system controller 22 calculates the number of lines L between a zero-cross position y0 at which the differential value SSn(y) changes from a negative value to a positive value and a zero-cross position y1 at which the differential value SSn(y) changes from a negative value to a positive value.

Then, the system controller 22 calculates the flicker frequency by calculating the reciprocal of the product of the calculated number of lines L and the readout time (1/(Z×M)) of the pixel value of one line. Here, the readout time of the pixel value of one line can be represented by the reciprocal of the product of the readout time Z (fps) of the pixel value of the entire image and the total number of lines M of the image.

### [2-1-2. Flicker Correction Processing]

When the flicker frequency is calculated, the imaging device 1 performs flicker correction processing for correcting and reducing the flicker on the basis of the calculated flicker frequency. As the flicker correction processing, a shutter speed correction mode for reducing flicker by changing a shutter speed and an image correction mode for reducing flicker by adding a flicker correction signal to an RGB primary color signal are provided.

The system controller 22 executes the shutter speed correction mode in a case where the mode selected by the user in advance is the shutter speed correction mode and is not the moving image capturing mode (in the case of the still image capturing mode).

On the other hand, the system controller 22 executes the image correction mode in a case where the mode selected by the user is the image correction mode and in a case where the mode selected by the user in advance is the shutter speed correction mode and the moving image capturing mode.

In the shutter speed correction mode, since the shutter speed is changed, there is a possibility that the shutter speed becomes too high at the time of capturing a moving image and a lagging and unnatural moving image is formed. Therefore, even when the mode selected by the user is the shutter speed mode, the image correction mode is executed in a case where the mode is the moving image capturing mode.

In the shutter speed correction mode, the system controller 22 instructs the timing generator 21 to operate at a shutter speed that is 1/N (N is a positive number) times the calculated flicker frequency.

Specifically, the system controller 22 sets the calculated flicker frequency to A, sets the shutter speed to B, determines whether A>B is satisfied or not, and in a case where A>B is satisfied, determines whether the absolute value of (A−B)>the absolute value of (A/2−B) is satisfied or not. In a case where the absolute value of (A−B)>the absolute value of (A/2−B) is satisfied, the system controller 22 updates A to A/2 and determines again whether A>B is satisfied or not.

Then, A is updated to A/2 until A>B is not satisfied any more or until the absolute value of (A−B)>the absolute value of (A/2−B) is not satisfied any more. Then, when A>B is not satisfied any more or the absolute value of (A−B)>the absolute value of (A/2−B) is not satisfied any more, the system controller 22 sets the current value of A to the shutter speed and instructs the timing generator 21 on the set shutter speed.

In this way, when the shutter speed is set to 1/N times the flicker frequency, the exposure times in all the lines are the same, and thus, flicker does not occur in an image outputted from the imaging element 14 even if the light source blinks at the flicker frequency.

In the image correction mode, flicker correction is performed to add a flicker correction signal generated on the basis of correction waveform data obtained by approximating flicker with a sine wave to an RGB primary color signal. Note that, in the image correction mode, for example, a known method such as the method described in Japanese Patent Application Laid-Open No. 2004-222228 can be used.

Specifically, the flicker detection unit 34 calculates the flicker intensity and the phase (an initial phase of the flicker stripe) by performing discrete Fourier transform on the differential value S(y) corresponding to one wavelength (L lines) of flicker. Then, the system controller 22 sends the correction information indicating the correction waveform data, the flicker intensity, and the phase corresponding to the flicker frequency to the flicker correction unit 36.

The flicker correction unit 36 generates a flicker correction signal having an amplitude corresponding to the flicker intensity and canceling the phase of the flicker from the correction waveform data indicated by the correction information, and performs flicker correction by adding the generated flicker correction signal to the RGB primary color signal.

Note that the flicker correction by the image correction mode is not limited to this method, and other methods may be used.

An RGB primary color signal subjected to the flicker correction processing in this manner is subjected to gradation conversion by the gamma correction circuit 37, an output luminance signal Y and color difference signals R-Y and B-Y are generated by the color conversion circuit 38, and thereafter, the image size is reduced by the image size conversion circuit 39. Then, the reduced image is displayed on the image display unit 18 by the flicker information superimposition unit 40.

Note that, although the image size conversion circuit 39 is provided because the number of display pixels of the image display unit 18 is smaller than that of the luminance signal Y and the color difference signals R-Y and B-Y, the image size conversion circuit 39 is unnecessary in a case where the number of display pixels is the same.

Therefore, flicker is reduced in an image displayed on the image display unit 18. Accordingly, the user can check an image in which flicker is reduced.

### [2-1-3. Flow of Processing]

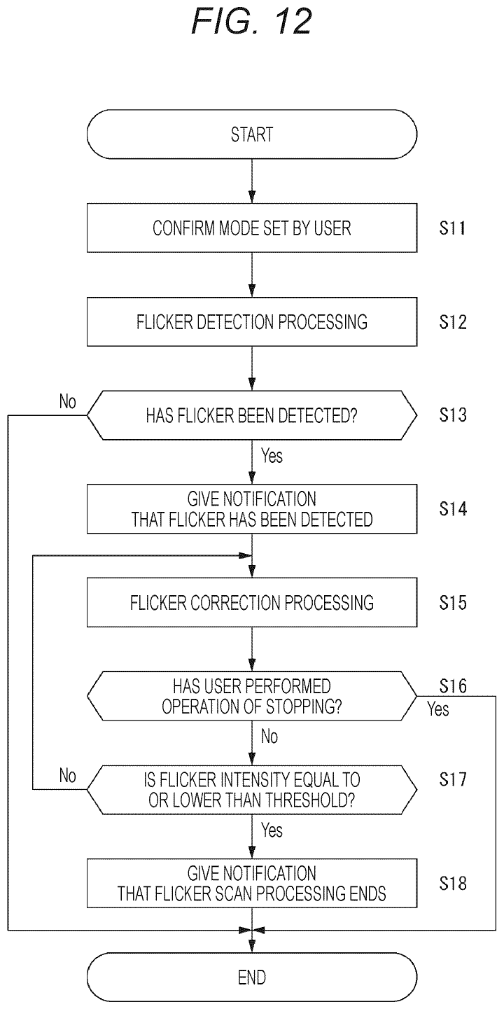

FIG. 12 is a flowchart for explaining a flow of flicker scan processing in Operation Example 1.

As illustrated in FIG. 12, when the flicker scan processing is executed, the system controller 22 confirms the mode of the flicker correction processing set by the user in step S11.

Then, in step S12, the flicker detection unit 34 executes flicker detection processing. Note that the flicker detection processing will be described later.

In step S13, the system controller 22 determines whether flicker has been detected or not and, in a case where no flicker has been detected (No in step S13), terminates the flicker scan processing. Note that, in a case where no flicker has been detected, the user may be notified that no flicker has been detected.

On the other hand, in a case where flicker has been detected (Yes in step S13), the system controller 22 gives a notification that flicker has been detected via the image display unit 18 in step S14, for example. Thereafter, in step S15, the system controller 22 and the flicker correction unit 36 execute flicker correction processing for correcting flicker. Note that the flicker correction processing will be described later.

When the flicker correction processing ends, the system controller 22 determines whether the user operation of stopping the flicker scan processing as described above has been performed or not in step S16. In a case where a user operation of stopping the flicker scan processing has been performed (Yes in step S16), the flicker scan processing ends.

On the other hand, in a case where a user operation of stopping the flicker scan processing has not been performed (No in step S16), the system controller 22 determines whether the flicker intensity of the flicker component included in the RGB primary color signal obtained after flicker correction has become equal to or lower than a predetermined threshold or not in step S17. Note that the flicker intensity may be calculated by frequency analysis as described later, or may be calculated on the basis of the differential value Sn(y).

Then, in a case where the flicker intensity is higher than the predetermined threshold (No in step S17), the process returns to step S15. On the other hand, in a case where the flicker intensity is equal to or lower than the predetermined threshold (Yes in step S17), the system controller 22 gives a notification that the flicker scan processing ends via the image display unit 18 and terminates the flicker scan processing in step S18.

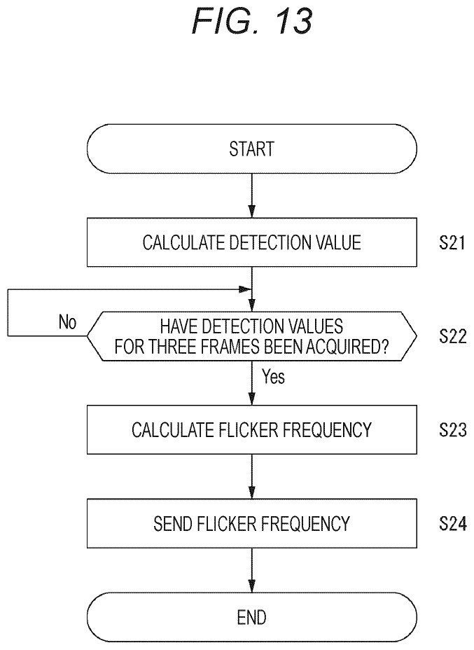

FIG. 13 is a flowchart for explaining a flow of flicker detection processing in Operation Example 1. As illustrated in FIG. 13, when RGB primary color signals for one frame are inputted, the flicker detection unit 34 calculates a detection value Fn(y) by integrating the inputted RGB primary color signals for each line in step S21.

Then, in step S22, the flicker detection unit 34 determines whether the detection values Fn−1(y), Fn(y), and Fn+1(y) for three adjacent frames have been acquired or not, and repeats steps S21 and S22 until the detection values for three adjacent frames are acquired (No in step S22).

On the other hand, in a case where the detection values for three adjacent frames are acquired (Yes in step S22), the flicker detection unit 34 calculates the flicker frequency in step S23. Here, a high-pass filter is applied to the detection values for three frames to calculate differential values Sn(y) and Sn+1(y). Furthermore, the flicker detection unit 34 calculates a differential value SSn(y) of the calculated differential values, and calculates a flicker frequency on the basis of the number of lines L between the zero-cross positions of the differential value SSn(y). Then, in step S24, the flicker detection unit 34 sends the calculated flicker frequency to the system controller 22.

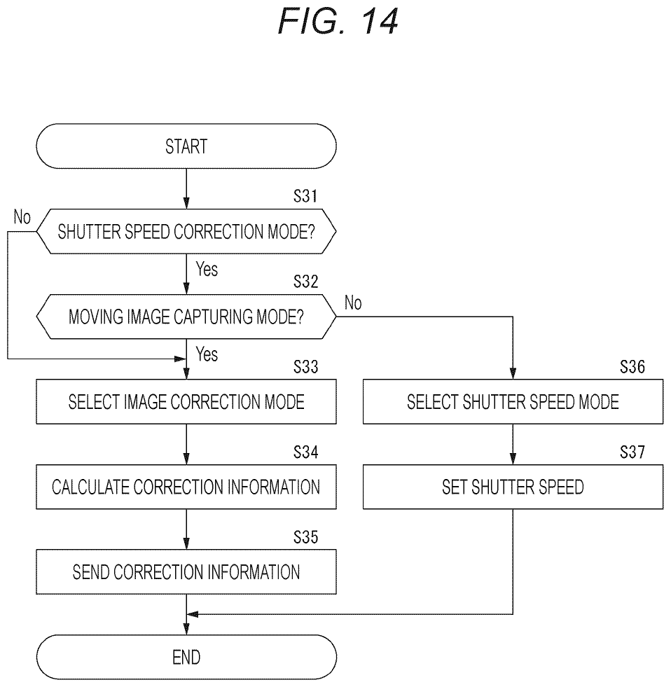

FIG. 14 is a flowchart for explaining a flow of flicker correction processing in Operation Example 1. In step S31, the system controller 22 determines whether the shutter speed correction mode has been selected or not. In a case where the shutter speed correction mode has been selected (Yes in step S31), the system controller 22 determines whether the moving image capturing mode has been selected or not in step S32.

In a case where the shutter speed correction mode is not selected (No in step S31) or in a case where the shutter speed correction mode is selected and the moving image capturing mode is selected (Yes in step S31, Yes in step S32), the system controller 22 selects the image correction mode in step S33.

Then, in step S34, the system controller 22 calculates correction waveform data, flicker intensity, and a phase for performing flicker correction on the basis of the calculated flicker frequency. Thereafter, in step S35, the system controller 22 sends correction information indicating the calculated correction waveform data, flicker intensity, and phase to the flicker correction unit 36. The flicker correction unit 36 generates a flicker correction signal having an amplitude corresponding to the flicker intensity and canceling the phase of the flicker from the correction waveform data indicated by the correction information, and performs flicker correction by adding the generated flicker correction signal to the RGB primary color signal.

On the other hand, in a case where the shutter speed correction mode is selected and the moving image capturing mode is not selected (Yes in step S31, No in step S32), that is, in a case where the still image capturing mode is selected, the system controller 22 selects the shutter speed correction mode in step S36.

Then, in step S37, the system controller 22 performs flicker correction processing by the shutter speed correction mode.

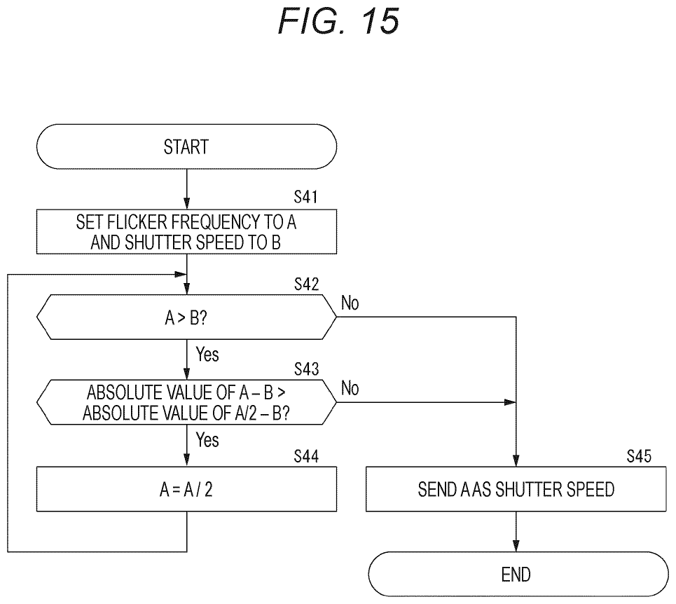

FIG. 15 is a flowchart for explaining a flow of flicker correction processing by a shutter speed correction mode.

As illustrated in FIG. 15, when the flicker correction processing by the shutter speed correction mode starts, the system controller 22 sets the flicker frequency to A and the shutter speed to B in step S41, and determines whether A>B is satisfied or not in step S42.

In a case where A>B is satisfied (Yes in step S42), the system controller 22 determines in step S43 whether the absolute value of (A−B)>the absolute value of (A/2−B) is satisfied or not.

In a case where the absolute value of (A−B)>the absolute value of (A/2−B) is satisfied (Yes in step S43), the system controller 22 updates A to A/2 in step S44 and returns the process to step S42.

On the other hand, in a case where A>B is not satisfied (No in step S42) or in a case where the absolute value of (A−B)>the absolute value of (A/2−B) is not satisfied (No in step S43), the system controller 22 sets the current value of A to the shutter speed and instructs the timing generator 21 to set the shutter speed to the set shutter speed in step S45.

Note that, in the flicker correction processing (FIG. 14) in Operation Example 1, the image correction mode is set in a case where the shutter speed correction mode is selected and the moving image capturing mode is selected, and the shutter speed correction mode is set in a case where the shutter speed correction mode is selected and the still image capturing mode is selected. However, regardless of whether or not the shutter speed correction mode is selected, the image correction mode may be set in a case where the moving image capturing mode is selected, and the shutter speed correction mode may be set in a case where the still image capturing mode is selected.

### [2-2. Flicker Detection Processing in Operation Example 2]

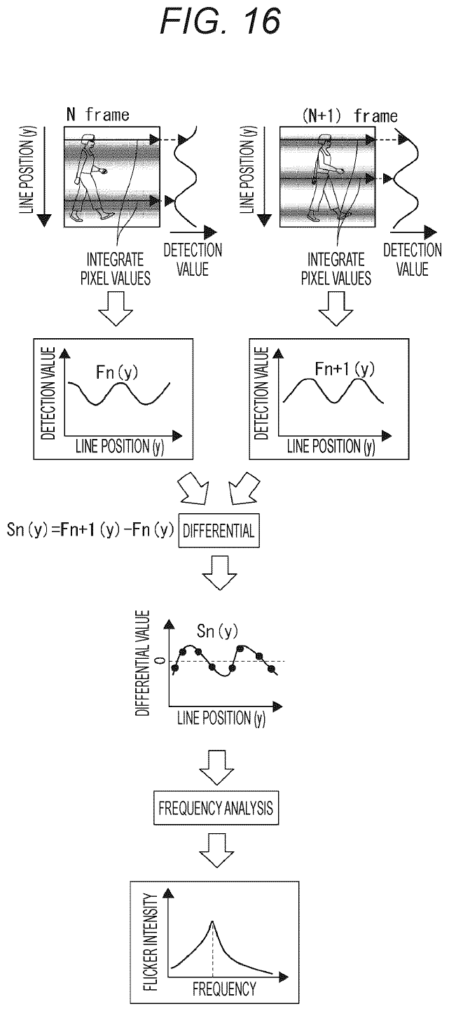

FIG. 16 is a diagram for explaining flicker detection processing in Operation Example 2. In Operation Example 2, since the flicker detection processing is different from that of Operation Example 1 and the other processes are the same, only the flicker detection processing will be described here.

As illustrated in FIG. 16, the flicker detection unit 34 integrates the signal levels of inputted RGB primary color signals for one line to calculate a detection value Fn(y). The calculated detection value Fn(y) is stored and held for flicker detection in subsequent frames.

The flicker detection unit 34 calculates a differential value Sn(y) between the detection value Fn+1(y) and the detection value Fn(y) by subtracting the detection value Fn(y) of the same line from the detection value Fn+1(y) of one frame after. Calculating the differential value Sn(y) functions as a so-called high-pass filter because the influence of a moving subject is sufficiently removed and a flicker component remains. Furthermore, the differential value Sn(y) corresponds to a high-pass filter processing result value obtained by performing the high-pass filter processing. Note that, although high-pass filter processing is performed on detection values of two adjacent frames here, the high-pass filter processing may be performed on detection values of a plurality of adjacent frames.

The flicker detection unit 34 performs frequency analysis on the differential value Sn(y). As the frequency analysis, discrete Fourier transform (DFT) or fast Fourier transform (FFT) can be considered. However, in a case where the number of lines is the N-th power of 2, the processing load can be reduced and the processing speed can be increased by performing the fast Fourier transform.

Then, the flicker detection unit 34 estimates (calculates) the frequency at which the flicker intensity (power spectrum) is the maximum value as the flicker frequency on the basis of the result of the frequency analysis. Then, the flicker detection unit 34 sends the estimated flicker frequency to the system controller 22.

Here, the flicker frequency estimated on the basis of the result of the frequency analysis may have low estimation accuracy due to low frequency resolution.

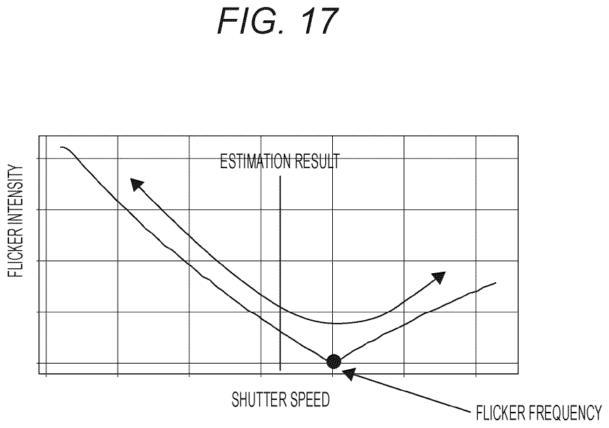

FIG. 17 is a diagram for explaining a relationship between a shutter speed and flicker intensity. As illustrated in FIG. 17, in a case where flicker is occurring, the maximum value of the flicker intensity is minimized when the shutter speed is the same as the flicker frequency.

Thus, the system controller 22 gradually changes the shutter speed higher and lower within a predetermined range based on the shutter speed corresponding to the flicker frequency (referred to as an estimation result in the figure) estimated by the frequency analysis. Then, the flicker detection unit 34 performs high-pass filter and frequency analysis on the image (RGB primary color signal) outputted from the imaging element 14 for each changed shutter speed, and respectively calculates the maximum value of the flicker intensity.

Then, the flicker detection unit 34 determines, as the flicker frequency, a frequency corresponding to the shutter speed at which the maximum value of the flicker intensity becomes minimum from among the maximum values of the flicker intensity for each changed shutter speed.

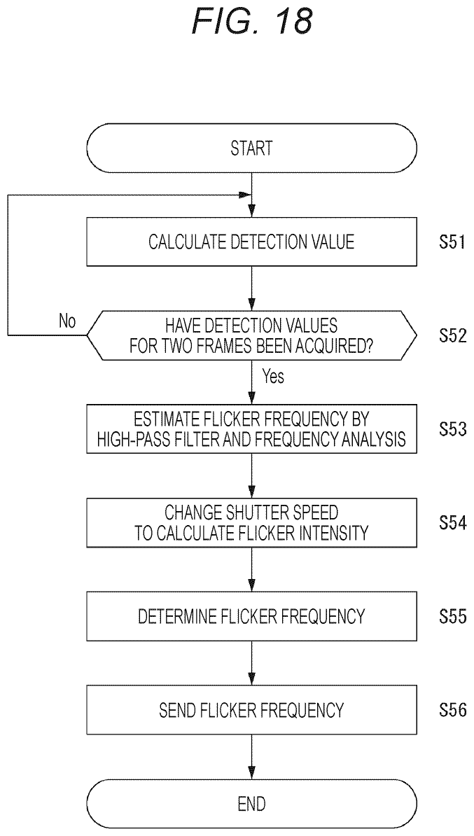

FIG. 18 is a flowchart for explaining a flow of flicker detection processing in Operation Example 2. As illustrated in FIG. 18, when RGB primary color signals for one frame are inputted, the flicker detection unit 34 calculates a detection value Fn(y) by integrating the inputted RGB primary color signals for each line in step S51.

Then, in step S52, the flicker detection unit 34 determines whether the detection values Fn(y) and Fn+1(y) for two adjacent frames have been acquired or not, and repeats steps S51 and S52 until detection values for two adjacent frames are acquired (No in step S52).

On the other hand, in a case where detection values for two adjacent frames have been acquired (Yes in step S52), the flicker detection unit 34 calculates a differential value Sn(y) with respect to the detection values for two adjacent frames by the high-pass filter, and estimates the flicker frequency by performing frequency analysis on the differential value in step S53.

In step S54, the system controller 22 gradually changes the shutter speed higher and lower within a predetermined range based on the shutter speed corresponding to the flicker frequency estimated by the frequency analysis. Then, the flicker detection unit 34 performs high-pass filter and frequency analysis on the image (RGB primary color signal) outputted from the imaging element 14 for each changed shutter speed, and respectively calculates the maximum value of the flicker intensity.

In step S55, the flicker detection unit 34 determines, as the flicker frequency, a frequency corresponding to the shutter speed at which the maximum value of the flicker intensity becomes minimum from among the maximum values of the flicker intensity for each changed shutter speed. Then, in step S56, the flicker detection unit 34 sends the determined flicker frequency to the system controller 22.

### 2-3. Operation Example 3

In Operation Example 3, flicker scan processing of informing the user of the flicker region and the flicker intensity is performed on the basis of the flicker intensity region information calculated by the flicker detection unit 34.

### [2-3-1. Flicker Detection Processing in Operation Example 3]

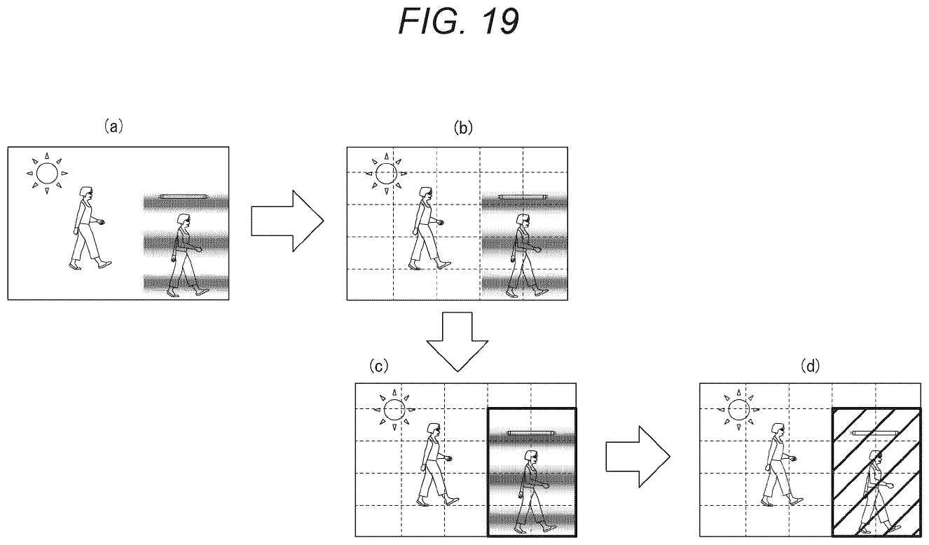

FIG. 19 is a diagram for explaining flicker detection processing in Operation Example 3. As illustrated in FIG. 19(a), for example, it is assumed that flicker is occurring in a part of an image. In the flicker detection processing in Operation Example 3, as indicated by the broken lines in FIG. 19(b), the flicker detection unit 34 divides an image based on inputted RGB primary color signals into a plurality of regions in the horizontal direction and the vertical direction. Here, for example, the flicker detection unit 34 performs the division with a plurality of adjacent pixels of one line as one region.

Then, the flicker detection unit 34 integrates the signal levels of the RGB primary color signals for each of the divided regions to calculate a detection value Fn(y). Then, the flicker detection unit 34 sets a region continuous in the vertical direction (region continuous in up-down direction in FIG. 19(b)) as one block, and executes flicker detection processing similar to that of Operation Example 1 or Operation Example 2 for each block. Therefore, the flicker detection unit 34 calculates the flicker frequency for each block.

The flicker detection unit 34 calculates the flicker intensity by performing discrete Fourier transform on the detection value Fn(y) for each region. Here, for example, the flicker intensity may be calculated from a temporal change in the average value of the detection value Fn(y) for each region, or the flicker intensity may be calculated by another method.

Then, as illustrated in FIG. 19(c), when calculating the flicker intensity for all the regions, the flicker detection unit 34 recognizes a region where the flicker intensity is equal to or higher than a threshold in each region as a region where the flicker is occurring. Furthermore, in a case where the flicker frequency and the flicker intensity of upper-and-lower or right-and-left adjacent regions where flicker is occurring are within a predetermined error range, the flicker detection unit 34 determines that the same flicker is occurring.

In this way, when extracting a region where flicker is occurring as the flicker region as surrounded by the thick lines in FIG. 19(c), the flicker detection unit 34 sends information (position information) on the flicker region and information on the flicker intensity of the flicker region to the flicker information superimposition unit 40 or the system controller 22 as the flicker intensity region information.

As illustrated in FIG. 19(d), when the flicker intensity region information is inputted, the flicker information superimposition unit 40 superimposes an image showing a flicker occurrence state on an image that has been image-sized by the image size conversion circuit 39, that is, an image obtained after flicker correction by the shutter speed correction mode or the image correction mode. An image showing the flicker occurrence state is displayed at a position corresponding to the flicker region indicated in the flicker intensity region information in a display form corresponding to the flicker intensity of the flicker region. Therefore, it is possible to notify the user of the region where the flicker is occurring and the flicker intensity in the region.

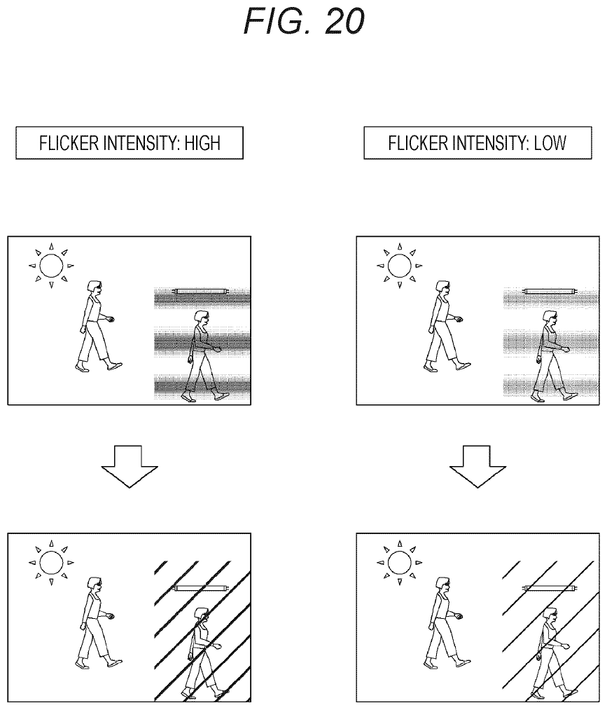

FIG. 20 is a diagram for explaining an example of an image showing a flicker occurrence state. As illustrated in FIG. 20, an image showing the flicker occurrence state is displayed with hatching having a thickness corresponding to the flicker intensity of the flicker region in the flicker region. More specifically, the image showing the flicker occurrence state is displayed such that the line thickness increases as the flicker intensity increases.

In this manner, by displaying the image showing the flicker occurrence state to be superimposed on the image obtained after the flicker correction, it is possible to allow the user to confirm the region where the flicker is occurring and the flicker intensity thereof even in an image in which the flicker has been corrected and reduced.

Note that the image showing the flicker occurrence state is only required to be displayed in a display form corresponding to the flicker intensity, and for example, may be displayed in a color corresponding to the flicker intensity, or may be displayed with lines having density corresponding to the flicker intensity.

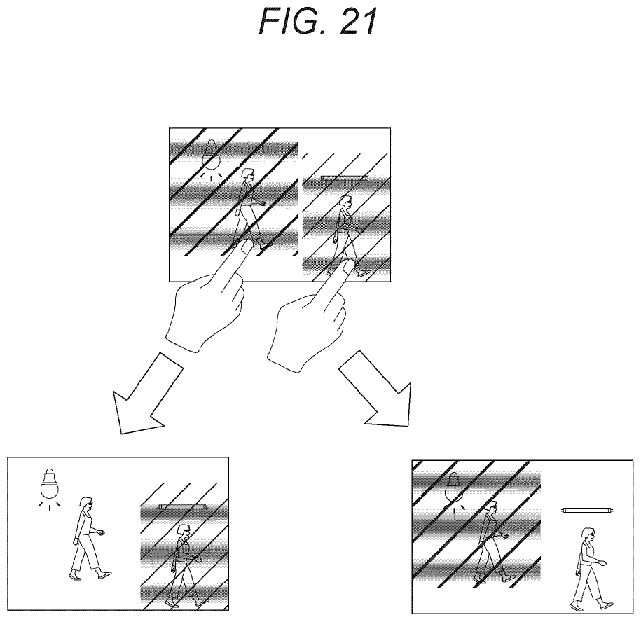

FIG. 21 is a diagram for explaining flicker correction processing in a case where a plurality of flicker regions is generated. As illustrated in FIG. 21, for example, it is assumed that flicker regions are generated at two locations. Furthermore, it is assumed that flicker is occurring with different flicker frequencies and flicker intensities in the respective flicker regions.

In such a case, if flicker correction is performed in accordance with the flicker frequency in one flicker region in the flicker correction mode described above, there is a possibility that the flicker in the other flicker region cannot be reduced.

Thus, first, as illustrated in FIG. 21, the flicker information superimposition unit 40 superimposes an image showing a flicker occurrence state on a plurality of flicker regions. Then, the system controller 22 causes the user to select a flicker region in which the flicker is to be reduced by the shutter speed correction mode from among the plurality of flicker regions. Here, for example, any flicker region is only required to be selected by a touch operation on a touch panel.

Then, when any flicker region is selected via the touch panel, the system controller 22 performs flicker correction processing by the shutter speed correction mode on the basis of the flicker frequency of the selected flicker region.

Therefore, the shutter speed is set to 1/N times the flicker frequency of the selected flicker region, and the flicker of the selected flicker region is reduced as illustrated in the lower part of FIG. 21.

The flicker detection unit 34 performs the flicker detection processing on the image outputted from the imaging element 14 after the flicker correction processing in the shutter speed correction mode is performed on the basis of the flicker frequency of the flicker region selected by the user. Then, in a case where a flicker region is detected in the flicker detection processing, the system controller 22 performs flicker correction processing by an image correction mode similar to that of Operation Example 1 or Operation Example 2 on the detected flicker region.

The system controller 22 corrects the flicker in the detected flicker region by performing the flicker correction processing by the image correction mode on the detected flicker region.

As described above, even in a case where a plurality of flicker regions is generated, the system controller 22 and the flicker correction unit 36 correct the flicker in the selected flicker region by the shutter speed correction mode, and correct the flicker in the flicker region detected thereafter in the image correction mode.

Therefore, even in a case where a plurality of flicker regions having different flicker frequencies is generated in an image, it is possible to reduce the flickers in all flicker regions.

Note that, although the flicker correction processing in the shutter speed correction mode is performed for the flicker region selected by the user, the flicker correction processing by the image correction mode may also be performed on the flicker region. That is, in a case where a plurality of different flicker regions is generated in an image, the flicker correction processing by the image correction mode may be performed on all the flicker regions.

However, by performing the flicker correction processing in the shutter speed correction mode on the basis of the flicker frequency of the flicker region selected by the user, there is a possibility that flicker in a region other than the flicker region selected by the user is also reduced. In such a case, since there is a case where it is unnecessary to perform the flicker correction processing by the image correction mode on the flicker region in which the flicker has been reduced, it is possible to reduce the processing load and perform efficient flicker correction.

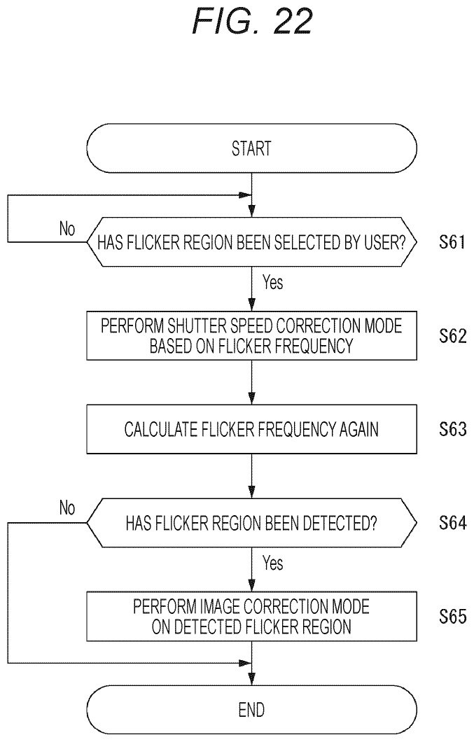

FIG. 22 is a flowchart for explaining a flow of flicker correction processing in a case where a plurality of flicker regions is detected. As illustrated in FIG. 22, in a case where a plurality of flicker regions is detected, the system controller 22 determines in step S61 whether any flicker region has been selected by the user or not. Step S61 is repeated until a flicker region is selected by the user, and in a case where any flicker region is selected by the user (Yes in step S61), the system controller 22 performs the flicker correction processing in the shutter speed correction mode based on the flicker frequency of the selected flicker region in step S62.

After the flicker correction processing by the shutter speed correction mode is performed, the flicker detection unit 34 performs flicker detection processing on an image newly outputted from the imaging element 14 in step S63.

In step S64, the system controller 22 determines whether a flicker region has been detected in step S63 or not, and in a case where no flicker region has been detected (No in step S64), terminates the flicker correction processing.

On the other hand, in a case where the flicker region has been detected (Yes in step S64), the system controller 22 performs the flicker correction processing in the image correction mode on the detected flicker region in step S65, and terminates the flicker correction processing.

### 2-4. Operation Example 4

In Operation Example 4, the shutter speed is changed in response to a user operation during execution of the flicker scan processing. Here, when the flicker correction processing as in Operation Example 1 to Operation Example 3 described above is performed, ideally, no flicker occurs in an image captured thereafter. However, if there is an error between the flicker frequency calculated in the flicker detection processing and the frequency of the flicker actually occurring, there is a possibility that the flicker is not sufficiently reduced in the flicker correction processing.

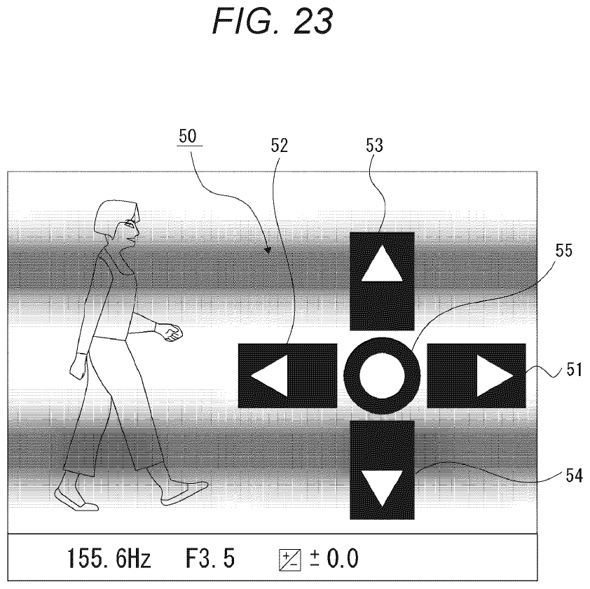

FIG. 23 is a diagram for explaining an example of the flicker adjustment UI (user interface) 50. Thus, the system controller 22 causes the image display unit 18 to display the flicker adjustment UI 50 illustrated in FIG. 23 in a case where the flicker intensity of the image (RGB primary color signal) subjected to the flicker correction processing is larger than a predetermined threshold, that is, in a case where the flicker has not completely disappeared.

Furthermore, even in a case where the flicker intensity is equal to or lower than the predetermined threshold, the system controller 22 causes the image display unit 18 to display the flicker adjustment UI 50 since there is a possibility that the moving image lags in a case where the moving image capturing mode is set. Note that the system controller 22 may cause the image display unit 18 to display the flicker adjustment UI 50 regardless of the flicker intensity in a case where the moving image capturing mode is set.

Moreover, in a case where a setting for displaying the flicker adjustment UI 50 on the image display unit 18 is made by the user, the system controller 22 causes the image display unit 18 to display the flicker adjustment UI 50.

The flicker adjustment UI 50 is an interface for changing the shutter speed in response to a user operation, and includes a plus multiple adjustment button 51, a minus multiple adjustment button 52, a plus fine adjustment button 53, a minus fine adjustment button 54, and an end button 55.

The plus multiple adjustment button 51 and the minus multiple adjustment button 52 are operation tools for roughly adjusting the shutter speed, and specifically, are operation tools capable of changing the shutter speed to any of 1/N (N is a positive number) times the detected flicker frequency. The plus multiple adjustment button 51 is an operation tool for setting the shutter speed to 1/(N−1) times. The minus multiple adjustment button 52 is an operation tool for setting the shutter speed to 1/(N+1) times. Here, note that the shutter speed is set to match the flicker frequency when N=1 is satisfied.

Accordingly, the shutter speed increases every time the plus multiple adjustment button 51 is pressed, and the shutter speed decreases every time the minus multiple adjustment button 52 is pressed. However, the upper limit value of the shutter speed is set to one time the flicker frequency. Then, in a case where the shutter speed is the upper limit value, the shutter speed does not increase even if the plus multiple adjustment button 51 is operated.

The plus fine adjustment button 53 and the minus fine adjustment button 54 are operation tools for finely adjusting the shutter speed. The plus fine adjustment button 53 is an operation tool for increasing the shutter speed by several Hz, for example. The minus multiple adjustment button 52 is an operation tool for decreasing the shutter speed by several Hz.

Accordingly, the shutter speed increases every time the plus fine adjustment button 53 is pressed, and the shutter speed decreases every time the minus fine adjustment button 54 is pressed.

In this manner, by allowing the user to operate the plus fine adjustment button 53 and the minus fine adjustment button 54, it is also possible to manually finely adjust the shutter speed to reduce flicker.

The end button 55 is an operation tool for hiding the flicker adjustment UI 50. When the end button 55 is operated, the flicker adjustment UI 50 is hidden.

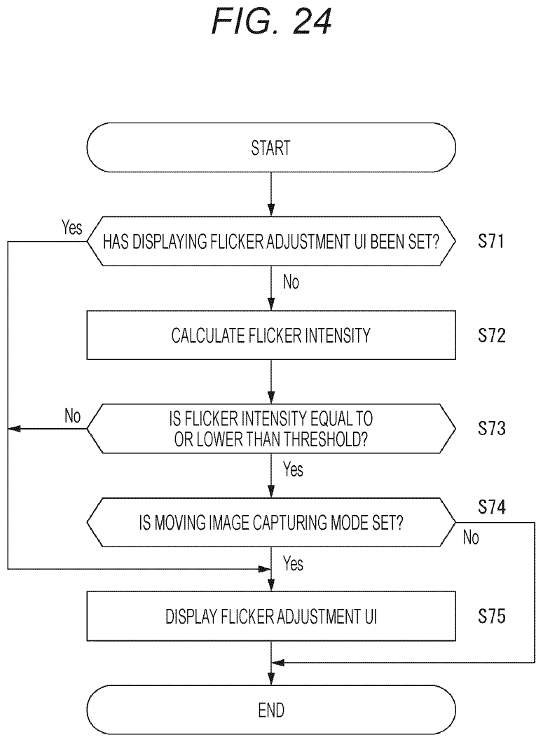

FIG. 24 is a flowchart for explaining a flow of flicker adjustment UI display processing in Operation Example 4. As illustrated in FIG. 24, in step S71, the system controller 22 determines whether a setting for displaying the flicker adjustment UI 50 on the image display unit 18 has been made by the user or not. In a case where no setting for displaying the flicker adjustment UI 50 on the image display unit 18 has been made (No in step S71), the flicker detection unit 34 detects the flicker intensity of the image outputted from the imaging element 14 after the flicker correction processing in step S72.

In step S73, the system controller 22 determines whether the flicker intensity is equal to or lower than the threshold or not, and in a case where the flicker intensity is lower than the threshold (Yes in step S73), determines whether the moving image capturing mode is set or not in step S74.

In a case where a setting for displaying the flicker adjustment UI 50 on the image display unit 18 has been made (Yes in step S71) or in a case where the flicker intensity is higher than the threshold (NO in step S73), the system controller 22 displays the flicker adjustment UI 50 on the image display unit 18 in step S75. Furthermore, in a case where the flicker intensity is equal to or lower than the threshold (Yes in step S73) and the moving image capturing mode is set (Yes in step S74), the system controller 22 also displays the flicker adjustment UI 50 on the image display unit 18 in step S75.

On the other hand, in a case where the flicker intensity is equal to or lower than the threshold (Yes in step S73) and the moving image capturing mode is not set (No in step S74), that is, in a case where the still image capturing mode is set, the system controller 22 terminates the flicker adjustment UI display processing without displaying the flicker adjustment UI 50 on the image display unit 18.

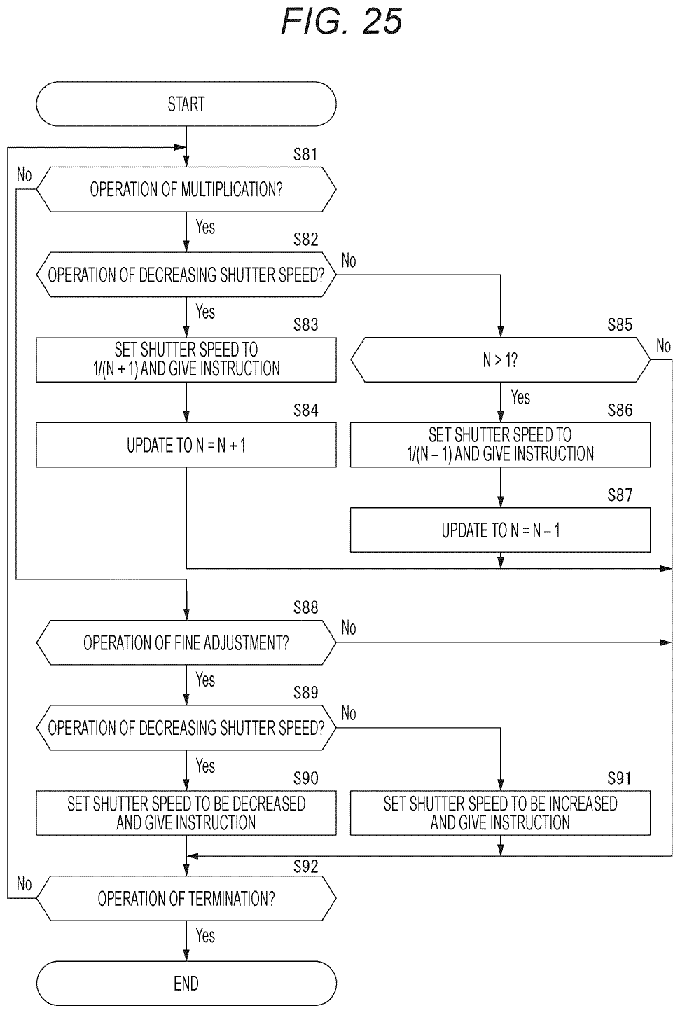

FIG. 25 is a flowchart for explaining a flow of shutter speed change processing with respect to an operation of the flicker adjustment UI 50. As illustrated in FIG. 25, in step S81, the system controller 22 determines whether an operation of multiplying the shutter speed has been performed or not. Here, whether the plus multiple adjustment button 51 or the minus multiple adjustment button 52 has been operated or not is detected.

Then, in a case where an operation of multiplying the shutter speed has been performed (Yes in step S81), the system controller 22 determines whether an operation of decreasing the shutter speed has been performed or not in step S82. Here, whether the minus multiple adjustment button 52 has been operated or not is detected.

Then, in a case where an operation of decreasing the shutter speed has been performed (Yes in step S82), the system controller 22 sets the shutter speed to 1/(N+1) times in step S83, and instructs the timing generator 21 on the shutter speed. Furthermore, in step S84, the system controller 22 updates N to N+1.

In a case where an operation of decreasing the shutter speed has not been performed (No in step S82), that is, in a case where the plus multiple adjustment button 51 has been operated, the system controller 22 determines whether N is larger than 1 or not in step S85. Then, in a case where N is larger than 1 (Yes in step S85), the system controller 22 sets the shutter speed to 1/(N−1) times in step S86, and instructs the timing generator 21 on the shutter speed. Furthermore, in step S87, the system controller 22 updates N to N−1.

Furthermore, in a case where an operation of multiplying the shutter speed has not been performed (No in step S81), the system controller 22 determines in step S88 whether an operation of finely adjusting the shutter speed has been performed or not. Here, whether the plus fine adjustment button 53 or the minus fine adjustment button 54 has been operated or not is detected.

Then, in a case where an operation of finely adjusting the shutter speed has been performed (Yes in step S88), the system controller 22 determines in step S89 whether an operation of decreasing the shutter speed has been performed or not. Here, whether the minus fine adjustment button 54 has been operated or not is detected.

Then, in a case where an operation of decreasing the shutter speed has been performed (Yes in step S89), the system controller 22 sets the shutter speed to be decreased by several Hz in step S90, and instructs the timing generator 21 on the shutter speed.

In a case where an operation of decreasing the shutter speed has not been performed (No in step S89), that is, in a case where the plus fine adjustment button 53 is operated, the system controller 22 sets the shutter speed to be increased by several Hz in step S91, and instructs the timing generator 21 on the shutter speed.

When these processes end, the system controller 22 determines in step S92 whether an operation of hiding the flicker adjustment UI 50 has been performed or not. Here, whether the end button 55 has been operated or not is detected.

Then, in a case where no operation of hiding the flicker adjustment UI 50 has been performed (No in step S92), the process returns to step S81. On the other hand, in a case where an operation of hiding the flicker adjustment UI 50 has been performed (Yes in step S92), the system controller 22 hides the flicker adjustment UI 50 and terminates the shutter speed change processing.

### 3. Variations

Note that the embodiment is not limited to the specific examples described above and may be configured as various variations.

For example, although the digital signal processing unit 17 functions as the clamp circuit 31, the gain adjustment circuit 32, the white balance adjustment circuit 33, the flicker detection unit 34, the display switching unit 35, the flicker correction unit 36, the gamma correction circuit 37, the color conversion circuit 38, the image size conversion circuit 39, and the flicker information superimposition unit 40, some or all of these functional units may be provided in the system controller 22.

Furthermore, although a case where the imaging device 1 is a camera has been described, the imaging device 1 may be a personal computer (PC), a smartphone, or the like. For example, in a case where the imaging device 1 is a smartphone, since the smartphone has few operation tools 6, various GUIs may be used instead of the operation tools 6. For example, when a zoom icon for changing zoom and a focus icon for changing focus are displayed on the image display unit, an icon for executing the flicker scan processing may be displayed side by side with these icons.

Furthermore, a menu icon for displaying the menu screen and an icon for executing the flicker scan processing may be displayed side by side with these icons.

Furthermore, an icon for executing the flicker scan processing may be displayed side by side with these icons in the vicinity of a region where the shutter speed is displayed. When a pop-up for changing the shutter speed is displayed, an icon for executing the flicker scan processing may be displayed side by side with these icons in the pop-up.

Furthermore, in the embodiment, the flicker detection unit 34 calculates the detection value in the flicker scan processing by integrating the signal levels (pixel values) of the RGB primary color signals. However, the flicker detection unit 34 is only required to calculate the detection value on the basis of the pixel value of the image outputted from the imaging element 14, and for example, may be configured to calculate the detection value by converting the RGB primary color signal into a luminance/color difference signal and integrating the luminance values that are the signal levels of the respective pixel values of the luminance signals.

Furthermore, in the embodiment, the flicker detection unit 34 calculates the detection value in the flicker scan processing by integrating the signal levels (pixel values) of the RGB primary color signals for each line. However, the flicker detection unit 34 may calculate the detection value by integrating signal levels (pixel values) for a plurality of consecutive lines each.

Furthermore, in the embodiment, the flicker detection unit 34 calculates the detection value in the flicker scan processing by integrating the signal levels (pixel values) of all the pixels in one line. However, the flicker detection unit 34 may calculate the detection value by integrating pixel values in a partial range (position range) of pixels in one line.

That is, the flicker detection unit 34 may calculate the detection value by integrating the pixel values in the entire or partial position range of each line for a plurality of consecutive lines each in each image. Note that, in a case where a partial position range is set for a plurality of consecutive lines each, it is desirable to set the same position range for each line, that is, to set a rectangular region.

Furthermore, in the embodiment, for example, in a case where the flicker is detected for the entire frame as in Operation Example 1, the flicker detection unit 34 calculates the detection value by integrating the pixel values of the entire one line. However, when the flicker is detected for the entire frame, the detection value may be calculated by calculating the detection value for each region and combining the calculation results in the respective regions as in Operation Example 3.

### 4. Summary

According to the above-described embodiments, the following effects can be obtained.

The imaging device 1 according to the embodiment includes the imaging element 14, the flicker detection unit 34 that detects a flicker component from an image outputted from the imaging element 14, a correction unit (the flicker correction unit 36, the timing generator 21) that corrects a flicker component included in the image, and a control unit (the system controller 22, the flicker information superimposition unit 41) that makes a flicker detection adaptive setting that facilitates detection of a flicker component in the flicker detection unit 34 in response to a shift from the normal imaging mode to the flicker detection mode and causes the image display unit 18 to display an image in which the flicker component has been corrected by the correction unit.

Therefore, the imaging device 1 can easily detect the flicker by the flicker detection unit 34, can improve the flicker detection accuracy, and can allow the user to confirm the image in which the flicker has been corrected. Accordingly, the imaging device 1 can achieve both improvement in flicker detection accuracy and visibility of an image displayed on the image display unit.

Furthermore, in response to detection of the flicker component by the flicker detection unit in the flicker detection mode, the control unit shifts to a normal imaging mode that is a normal setting not considering the easiness of detection of the flicker component by the flicker detection unit.

Therefore, when flicker is detected from an image, the imaging device 1 shifts to the normal imaging mode, so that the image in which the flicker has been corrected can be captured early.

Furthermore, in response to correction of the flicker component by the correction unit, the control unit shifts to the normal imaging mode, which is a normal setting not considering the easiness of detection of the flicker component by the flicker detection unit. Therefore, when flicker is corrected from the image, the imaging device 1 shifts to the normal imaging mode, so that the image in which the flicker has been corrected can be captured early.

Furthermore, the control unit sets the number of pixels of the image outputted from the imaging element 14 to the number of pixels suitable for detecting the flicker component as the flicker detection adaptive setting.

Therefore, flicker can be easily detected from an image outputted from the imaging element 14, and the flicker detection accuracy can be improved.

Furthermore, the control unit sets the number of pixels of the image outputted from the imaging element 14 to be larger than that in the normal imaging mode as the flicker detection adaptive setting.

Therefore, the flicker detection unit 34 detects flicker from an image having a large number of pixels, and thus, it is easy to detect flicker, and it is possible to detect flicker information (frequency, intensity, region, etc.) accurately.

Furthermore, the control unit sets the shutter speed of the imaging element 14 to a speed suitable for detecting the flicker component as the flicker detection adaptive setting.

Therefore, flicker can be easily detected from an image outputted from the imaging element 14, and the flicker detection accuracy can be improved.

Furthermore, the control unit sets the shutter speed of the imaging element 14 to be higher than a predetermined speed as the flicker detection adaptive setting.

Therefore, the exposure time of each line in the image captured by the imaging element 14 can be decreased, the luminance decreases as a whole, and the contrast of the flicker can be increased. Accordingly, the flicker detection accuracy can be improved.

Furthermore, the control unit sets the readout time of the imaging element to a time suitable for detecting the flicker component as the flicker detection adaptive setting.

Therefore, flicker can be easily detected from an image outputted from the imaging element 14, and the flicker detection accuracy can be improved.

Furthermore, the control unit sets the readout time of the imaging element 14 to be longer than a predetermined time as the flicker detection adaptive setting.

Therefore, the number of flicker stripes generated in an image at the time of imaging by the imaging element 14 increases. Accordingly, the flicker detection accuracy can be improved.

Furthermore, a flicker region detection unit (flicker detection unit 34) that detects a flicker region where flicker is occurring in a frame of an image is provided.

Therefore, in a case where flicker is occurring in a part of the image, flicker correction can be performed on a region where the flicker is occurring.

Furthermore, the control unit performs control so that the flicker occurrence state is displayed for each region where the flicker is occurring.

Therefore, it is possible to notify the user of the occurrence state (intensity region) of flicker for each flicker region.

Furthermore, the control unit controls the image display unit 18 so that the flicker occurrence state is displayed in a form corresponding to the flicker intensity for each flicker region.

Therefore, it is possible to easily notify the user of the flicker intensity of the flicker region.

Furthermore, the control unit sets the correction unit to an image correction mode for correcting the flicker component by image processing in the case of the moving image capturing mode, and sets the correction unit to a shutter speed correction mode for correcting the flicker using the shutter speed in the case of the still image capturing mode.

Therefore, it is possible to reduce the possibility that the shutter speed becomes too high at the time of capturing a moving image and a lagging and unnatural moving image is generated. Furthermore, when a still image is captured, the processing load can be reduced by correcting flicker using the shutter speed.

Furthermore, in a case where the flicker intensity is higher than a threshold, the control unit causes the image display unit 18 to display a flicker adjustment user interface (flicker adjustment UI 50).

Therefore, it is possible to reduce confusion and annoyance of the user caused by displaying the flicker adjustment UI 50 in a case where the flicker intensity is lower than the threshold and no flicker is occurring.

Furthermore, the control unit causes the image display unit 18 to display the flicker adjustment user interface in the case of the moving image capturing mode.

Therefore, the shutter speed for reducing the flicker can be determined while checking the lagging of the moving image, so that the flicker can also be reduced while reducing the lagging of the moving image.

The control unit causes the image display unit 18 to display the flicker adjustment user interface in the moving image capturing mode and in a case where the flicker intensity is equal to or lower than the threshold.

Therefore, since the flicker adjustment UI 50 is displayed even in a case where no flicker is occurring or flicker is small, it is possible to reduce the flicker while reducing the lagging of the moving image.

Furthermore, the flicker adjustment user interface includes operation tools capable of roughly adjusting and finely adjusting the shutter speed.

Therefore, the exposure time of each line in the image captured by the imaging element 14 can be set to be the same by the rough adjustment, and flicker can be reduced. Furthermore, by fine adjustment, the shutter speed can be changed to a shutter speed at which flicker is further reduced while the user confirms the image obtained after flicker correction.

Furthermore, in a case where a plurality of flicker regions is generated in a frame, the correction unit sets the shutter speed to 1/N (N is a positive number) times the flicker frequency of any of the flicker regions.

Therefore, flicker in at least the selected flicker region can be reduced. Furthermore, there is a possibility that flicker in other regions can be reduced.

Furthermore, in the method of controlling the imaging device, the imaging device 1 detects a flicker component from an image outputted from the imaging element, corrects the flicker component included in the image, makes a flicker detection adaptive setting that facilitates detection of the flicker component in response to a shift from the normal imaging mode to the flicker detection mode, and causes the image display unit 18 to display an image in which the flicker component has been corrected.

Moreover, the program detects a flicker component from an image outputted from the imaging element, corrects the flicker component included in the image, makes a flicker detection adaptive setting that facilitates detection of the flicker component in response to a shift from the normal imaging mode to the flicker detection mode, and causes the image display unit 18 to display an image in which the flicker component has been corrected.

These programs can be recorded in advance in an HDD as a recording medium built in equipment such as a computer apparatus, a ROM in a microcomputer having a CPU, or the like. Alternatively, the program can be temporarily or permanently stored (recorded) on a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site via a network such as a local area network (LAN) or the Internet.

Note that the effects described in the present specification are merely examples and are not restrictive, and other effects may be exerted.

Note that the present technology can also have the following configurations.
(1)

An imaging device including:
an imaging element;
a flicker detection unit that detects a flicker component from an image outputted from the imaging element;
a correction unit that corrects the flicker component included in the image; and
a control unit that makes a flicker detection adaptive setting that facilitates detection of the flicker component in the flicker detection unit in response to a shift from a normal imaging mode to a flicker detection mode, and causes an image display unit to display an image in which the flicker component has been corrected by the correction unit.
(2)

The imaging device according to (1), in which
the control unit
shifts to the normal imaging mode that is a normal setting not considering easiness of detection of the flicker component by the flicker detection unit, in response to detection of the flicker component by the flicker detection unit in the flicker detection mode.
(3)

The imaging device according to (1) or (2), in which
the control unit
shifts to a normal imaging mode that is a normal setting not considering easiness of detection of the flicker component by the flicker detection unit, in response to correction of the flicker component by the correction unit.
(4)

The imaging device according to any one of (1) to (3), in which
the control unit sets the number of pixels of the image outputted from the imaging element to the number of pixels suitable for detection of the flicker component as the flicker detection adaptive setting.
(5)

The imaging device according to (4), in which
the control unit sets the number of pixels of the image outputted from the imaging element to be larger than that in the normal imaging mode as the flicker detection adaptive setting.
(6)

The imaging device according to any one of (1) to (5), in which
the control unit sets a shutter speed of the imaging element to a speed suitable for detection of the flicker component as the flicker detection adaptive setting.
(7)

The imaging device according to (6), in which
the control unit sets the shutter speed of the imaging element to be higher than a predetermined speed as the flicker detection adaptive setting.
(8)

The imaging device according to any one of (1) to (7), in which
the control unit sets a readout time of the imaging element to a time suitable for detection of the flicker component as the flicker detection adaptive setting.
(9)

The imaging device according to (8), in which
the control unit sets the readout time of the imaging element to be longer than a predetermined time as the flicker detection adaptive setting.
(10)

The imaging device according to any one of (1) to (9), including
a flicker region detection unit that detects a flicker region in which a flicker component is generated in a frame of an image.
(11)

The imaging device according to (10), in which
the control unit performs control in a manner such that a flicker occurrence state is displayed for each flicker region.
(12)

The imaging device according to (11), in which
the control unit controls the image display unit in a manner such that the flicker occurrence state is displayed in a form corresponding to a flicker intensity for each flicker region.
(13)

The imaging device according to any one of (1) to (12), in which
the control unit sets the correction unit to an image correction mode for correcting the flicker component by image processing in the case of a moving image capturing mode, and sets the correction unit to a shutter speed correction mode for correcting the flicker using a shutter speed in the case of a still image capturing mode.
(14)

The imaging device according to any one of (1) to (13), in which
the control unit causes the image display unit to display a flicker adjustment user interface in a case where flicker intensity is higher than a threshold.
(15)

The imaging device according to any one of (1) to (14), in which
the control unit causes the image display unit to display a flicker adjustment user interface in the case of a moving image capturing mode.
(16)

The imaging device according to (15), in which
the control unit causes the image display unit to display the flicker adjustment user interface in the case of a moving image capturing mode and in a case where the flicker intensity is equal to or lower than a threshold.
(17)

The imaging device according to any one of (14) to (16), in which
the flicker adjustment user interface includes an operation tool capable of roughly adjusting and finely adjusting a shutter speed.
(18)

The imaging device according to (10), in which
the correction unit sets a shutter speed to 1/N (N is a positive number) times a flicker frequency of any flicker region in a case where a plurality of flicker regions is generated in a frame.
(19)

A method of controlling an imaging device, including:
detecting a flicker component from an image outputted from an imaging element;
correcting the flicker component included in the image; and
making a flicker detection adaptive setting that facilitates detection of the flicker component in response to a shift from a normal imaging mode to a flicker detection mode, and causing an image display unit to display an image in which the flicker component has been corrected.
(20)

A program for causing an imaging device to execute processes of:
detecting a flicker component from an image outputted from an imaging element;
correcting the flicker component included in the image; and
making a flicker detection adaptive setting that facilitates detection of the flicker component in response to a shift from a normal imaging mode to a flicker detection mode, and causing an image display unit to display an image in which the flicker component has been corrected.

### REFERENCE SIGNS LIST

1 Imaging device
17 Digital signal processing unit
21 Timing generator
22 System controller
34 Flicker detection unit
37 Flicker correction unit

1. An imaging device comprising:
an imaging element;
a flicker detection unit that detects a flicker component from an image outputted from the imaging element;
a correction unit that corrects the flicker component included in the image; and
a control unit that makes a flicker detection adaptive setting that facilitates detection of the flicker component in the flicker detection unit in response to a shift from a normal imaging mode to a flicker detection mode, and causes an image display unit to display an image in which the flicker component has been corrected by the correction unit.

2. The imaging device according to claim 1, wherein
the control unit
shifts to the normal imaging mode that is a normal setting not considering easiness of detection of the flicker component by the flicker detection unit, in response to detection of the flicker component by the flicker detection unit in the flicker detection mode.

3. The imaging device according to claim 1, wherein
the control unit
shifts to a normal imaging mode that is a normal setting not considering easiness of detection of the flicker component by the flicker detection unit, in response to correction of the flicker component by the correction unit.

4. The imaging device according to claim 1, wherein
the control unit sets a number of pixels of the image outputted from the imaging element to a number of pixels suitable for detection of the flicker component as the flicker detection adaptive setting.

5. The imaging device according to claim 4, wherein
the control unit sets the number of pixels of the image outputted from the imaging element to be larger than that in the normal imaging mode as the flicker detection adaptive setting.

6. The imaging device according to claim 1, wherein
the control unit sets a shutter speed of the imaging element to a speed suitable for detection of the flicker component as the flicker detection adaptive setting.

7. The imaging device according to claim 6, wherein
the control unit sets the shutter speed of the imaging element to be higher than a predetermined speed as the flicker detection adaptive setting.

8. The imaging device according to claim 1, wherein
the control unit sets a readout time of the imaging element to a time suitable for detection of the flicker component as the flicker detection adaptive setting.

9. The imaging device according to claim 8, wherein
the control unit sets the readout time of the imaging element to be longer than a predetermined time as the flicker detection adaptive setting.

10. The imaging device according to claim 1, comprising
a flicker region detection unit that detects a flicker region in which a flicker component is generated in a frame of an image.

11. The imaging device according to claim 10, wherein
the control unit performs control in a manner such that a flicker occurrence state is displayed for each flicker region.

12. The imaging device according to claim 11, wherein
the control unit controls the image display unit in a manner such that the flicker occurrence state is displayed in a form corresponding to a flicker intensity for each flicker region.

13. The imaging device according to claim 1, wherein
the control unit sets the correction unit to an image correction mode for correcting the flicker component by image processing in a case of a moving image capturing mode, and sets the correction unit to a shutter speed correction mode for correcting the flicker using a shutter speed in a case of a still image capturing mode.

14. The imaging device according to claim 1, wherein
the control unit causes the image display unit to display a flicker adjustment user interface in a case where flicker intensity is higher than a threshold.

15. The imaging device according to claim 1, wherein
the control unit causes the image display unit to display a flicker adjustment user interface in a case of a moving image capturing mode.

16. The imaging device according to claim 15, wherein
the control unit causes the image display unit to display the flicker adjustment user interface in a case of a moving image capturing mode and in a case where the flicker intensity is equal to or lower than a threshold.

17. The imaging device according to claim 14, wherein
the flicker adjustment user interface includes an operation tool capable of roughly adjusting and finely adjusting a shutter speed.

18. The imaging device according to claim 10, wherein
the correction unit sets a shutter speed to 1/N (N is a positive number) times a flicker frequency of any flicker region in a case where a plurality of flicker regions is generated in a frame.

19. A method of controlling an imaging device, comprising:
detecting a flicker component from an image outputted from an imaging element;
correcting the flicker component included in the image; and
making a flicker detection adaptive setting that facilitates detection of the flicker component in response to a shift from a normal imaging mode to a flicker detection mode, and causing an image display unit to display an image in which the flicker component has been corrected.

20. A program for causing an imaging device to execute processes of:
detecting a flicker component from an image outputted from an imaging element;
correcting the flicker component included in the image; and
making a flicker detection adaptive setting that facilitates detection of the flicker component in response to a shift from a normal imaging mode to a flicker detection mode, and causing an image display unit to display an image in which the flicker component has been corrected.
